(19) United States
(12) Patent Application Publication
(10) Pub. No.: US 2006/0025931 A1
(43) Pub. Date: Feb. 2, 2006

(54) Method and apparatus for real time predictive modeling for chronically ill patients

(76) Inventors: Richard Rosen, Belmont, MA (US); Ian Hunter, Lincoln, MA (US)

Correspondence Address: GREENBERG TRAURIG LLP, MET LIFE BUILDING, 200 PARK AVENUE; 14TH FLOOR, NEW YORK, NY, 10166, US

(21) Appl. No.: 11/074,425

(22) Filed: Mar. 8, 2005

Related U.S. Application Data
(60) Provisional application No. 60/592,623, filed on Jul. 30, 2004.

(51) Int. Cl. G06F 19/00

(52) U.S. Cl. 702/19

(57) ABSTRACT

Various embodiments of the present invention are directed to a method and apparatus for improving the care of patients (e.g., chronically ill patients). In one example (which example is intended to be illustrative and not restrictive), the invention may be designed to improve such care through real time output (e.g., periodic, such as hourly, daily, weekly or monthly) to deter development of co-morbidities associated with many chronic diseases. Various embodiments of the invention may improve the care of chronically ill patients by: easing data collection, simplifying data transmission, efficiently interpreting chronically ill patient information, providing time series to form the basis of subsequent analysis, expanding the ability of the chronically ill patient or other user of the invention to understand the relationship between the medical practice and the patient's own lifestyle and/or easing the workload of healthcare providers (such as the patient's physician). In this regard, the invention may help in creating dialogue between chronically ill patients and healthcare providers that otherwise would be impossible.

### RELATED APPLICATIONS

This application claims the benefit of U.S. Provisional Application Ser. No. 60/592,623, filed Jul. 30, 2004.

### FIELD OF THE INVENTION

Various embodiments of the present invention are directed to a method and apparatus for improving the care of patients (e.g., chronically ill patients). In one example (which example is intended to be illustrative and not restrictive), the invention may be designed to improve such care through real time output (e.g., periodic, such as hourly, daily, weekly or monthly) to deter development of co-morbidities associated with many chronic diseases. Various embodiments of the invention may improve the care of chronically ill patients by: easing data collection, simplifying data transmission, efficiently interpreting chronically ill patient information, providing time series to form the basis of subsequent analysis, expanding the ability of the chronically ill patient or other user of the invention to understand the relationship between the medical practice and the patient's own lifestyle and/or easing the workload of healthcare providers (such as the patient's physician). In this regard, the invention may help in creating dialogue between chronically ill patients and healthcare providers that otherwise would be impossible.

In one specific embodiment, the invention may comprise at least one raw-data gathering device linked to one or more network sites where periodic data generated by a user, such as the chronically ill patient, and periodic data generated by additional outside sources, such as physicians and healthcare providers, are recorded, stored, analyzed and/or modeled (e.g., according the various mathematical calculation mechanisms described herein). In one example (which example is intended to be illustrative and not restrictive), output may be provided periodically (e.g., on a predetermined basis or schedule) to a user of the invention for review, such as on a television set, telephone (land line, mobile), wireless device and/or computer, and may be output to various sources, such as a physician (output may be provided separately or concurrently to numerous recipient(s), including (but not limited to) a chronically ill patient, the patient's caregiver and/or physician). In one example (which example is intended to be illustrative and not restrictive), output to a physician may be provided in such a way that the physician has access to summaries of the patient's progress. In another example (which example is intended to be illustrative and not restrictive), the output of the invention may be formatted according to the predictive modeling of the invention, meeting the specification of the user/patient, and may be used to analyze a patient's progress and/or to alter treatment should an urgent situation exist.

For the purposes of the present application the term “predictive modeling” is intended to refer to a broad mathematical category including (but not limited to): trend detection; variance detection, prediction and/or forecasting.

Further, for the purposes of the present application the term “real time” is intended to refer to an essentially contemporaneous or interactive process (as opposed to a process which occurs relatively slowly, in a “batch” or non-interactive manner).

### BACKGROUND OF THE INVENTION

Diabetes is a chronic disease that impairs the body's ability to use food. The hormone insulin, which is made in the pancreas, helps the body to use food for energy. In people with diabetes, either the pancreas doesn't make insulin or the body cannot use insulin properly. Without insulin, glucose—the body's main energy source—builds up in the blood. Approximately 90-95% of Americans with diabetes have Type 2 diabetes—about 16 million people.

Some of the symptoms of Type 2 diabetes are the same as those for Type 1 diabetes: (1) frequent urination; (2) excessive thirst and hunger; (3) dramatic weight loss; (4) irritability; (5) weakness and fatigue; and (6) nausea and vomiting.

Additional symptoms of Type 2 diabetes may include: (1) recurring or hard-to-heal skin; (2) gum or bladder infections; (3) blurred vision; (4) tingling or numbness in hands or feet; and (5) itchy skin.

Unlike Type 1 diabetes, symptoms for Type 2 diabetes typically occur gradually over months or even years, and some people with Type 2 diabetes have symptoms that are so mild they go unnoticed.

The causes of diabetes are still a mystery, but researchers have discovered that being overweight can trigger the onset of diabetes because excess fat prevents insulin from working properly. Type 2 diabetes is typically treated with exercise and an individual meal plan (e.g., designed to help maintain a healthy weight and keep blood glucose levels in check and avoid complications). If diet and exercise alone do not lower blood glucose levels, diabetes pills, insulin, or both may be needed in addition to diet and exercise.

Although diabetes cannot typically be cured, it can be treated. With proper treatment, daily care, and family support, a patient can lead a healthy, active life.

In this regard, such chronic diseases have typically been treated episodically (only in isolated, temporary intervals). More particularly, a chronically ill patient is identified as having a particular disease and is then scheduled for regular provider intervention at three, six, or twelve month intervals. For example, in diabetes, these interventions have been characterized by the employment of the Hemoglobin A1C test, a blood measurement which allows for the estimation of average blood sugar over the previous ninety days. In addition to this test, chronically ill diabetics may measure blood sugar at home and report averages from time to time to their healthcare provider. Relying on such average measurements, the chronically ill diabetic's physician will try to determine whether the particular treatment protocol that he has prescribed is working effectively. However, for many such chronically ill patients, including diabetics, little or no change occurs, and a significant number of chronically ill patients' conditions worsen.

It is believed that a material reason for these failures is that chronically ill patients lose their motivation to do the things that they need to do in order to control their diabetes. They irregularly take their drugs, eat improperly, and fail to get adequate exercise. Another reason for these failures can be explained by the reliance of medical professionals on aggregated data to develop treatment protocols and their use of simplistic statistics to analyze whatever data may be available.

For instance, relying solely on daily means of glucose levels may have a damping effect and may cause a chronically ill diabetic's glucose to appear better controlled than it actually is (the typical diabetic patient irregularly provides a single variable which may be employed to focus the nature of care for that particular chronically ill patient (i.e. blood sugar)—however, approximately 65% of all diabetic patients are also hypertensive; most are overweight; many fail to get adequate exercise; a significant number suffer from low oxygen saturation; and few such chronically ill patients currently have data on all of these important factors which can be employed to optimize care and provide treatment protocols which work to improve such care (and in addition are cost effective to the healthcare system)).

Finally, it is noted that various patient monitoring mechanisms have been proposed. Examples include the mechanisms described in the following patent documents.

U.S. Pat. No. 6,852,080 relates to a system and method for providing feedback to an individual patient for automated remote patient care. More particularly, this patent discloses that a medical device having a sensor for monitoring physiological measures of an individual patient regularly records a set of measures. A remote client processes voice feedback into a set of quality of life measures relating to patient self-assessment indicators. A database collects the collected measures set, the identified collected device measures set and the quality of life measures set into a patient care record for the individual patient. A server periodically receives the identified collected device measures set and the quality of life measures set from the medical device, and analyzes the identified collected device measures set, the quality of life measures set, and the collected device measures sets in the patient care record relative to other collected device measures sets stored in the database to determine a patient status indicator.

U.S. Pat. No. 6,383,136 relates to the health analysis and forecast of abnormal conditions. More particularly this patent discloses tracking the health status of a patient, including entering a plurality of health record signals. Each signal comprises a record of measurement of a predetermined health indicative parameter considered to be in a normal range related to the health status of the patient taken at different times. The health record signals are stored. The stored health record signals are processed to project a possible trend for the predetermined health parameter to assume a value in the abnormal range. A future abnormal indication signal is provided when the trend forecasts the predetermined parameter will assume a value in the abnormal range.

### BRIEF DESCRIPTION OF THE DRAWINGS

FIG. 1 is a flowchart illustrating a method according to an embodiment of the invention;

FIG. 2 is a graphical representation of a statistical summary of the incidence of complications or related diseases in diabetics;

FIG. 3 is a graphical representation of a statistical summary of the costs associated with common complications of diabetes;

FIG. 4 is a graphical outline representing the percentages of costs incurred by diabetics according to the type of care needed;

FIG. 5 is a graphical outline of the results of numerous clinical trials which demonstrated the potential to decrease the complications of diabetes;

FIG. 6 is a graphical outline summarizing what impact various intervention methods have on health events, including the costs avoided;

FIG. 7 is a set of graphical summaries of studies demonstrating the relationship between improved control of diabetes and improved care management and cost savings;

FIG. 8 is a set of tables illustrating the nature and timing of the clinical improvements and cost savings attributable to the application of an embodiment of the invention based on clinical trials depicted in FIGS. 3, 4, 5, 6 and 7;

FIG. 9 is a flowchart illustrating a system and method according to an embodiment of the invention (depicting the transfer of information between at least one measurement device and a patient “Data Managing Device”, wherein such transfer of information is from the measurement device(s) to the Data Managing Device and/or from the Data Managing Device to the measurement device(s)); and

FIG. 10 is a flowchart illustrating a system and method according to an embodiment of the invention (depicting the transfer of information between at least one “Virtual Private Network” device and an ISP server, wherein such transfer of information is from the Virtual Private Network device(s) to the ISP server and/or from the ISP server to the Virtual Private Network device(s)).

Among those benefits and improvements that have been disclosed, other objects and advantages of this invention will become apparent from the following description taken in conjunction with the accompanying figures. The figures constitute a part of this specification and include illustrative embodiments of the present invention and illustrate various objects and features thereof.

### DETAILED DESCRIPTION OF THE INVENTION

Detailed embodiments of the present invention are disclosed herein; however, it is to be understood that the disclosed embodiments are merely illustrative of the invention that may be embodied in various forms. In addition, each of the examples given in connection with the various embodiments of the invention are intended to be illustrative, and not restrictive. Further, the figures are not necessarily to scale, some features may be exaggerated to show details of particular components. Therefore, specific structural and functional details disclosed herein are not to be interpreted as limiting, but merely as a representative basis for teaching one skilled in the art to variously employ the present invention.

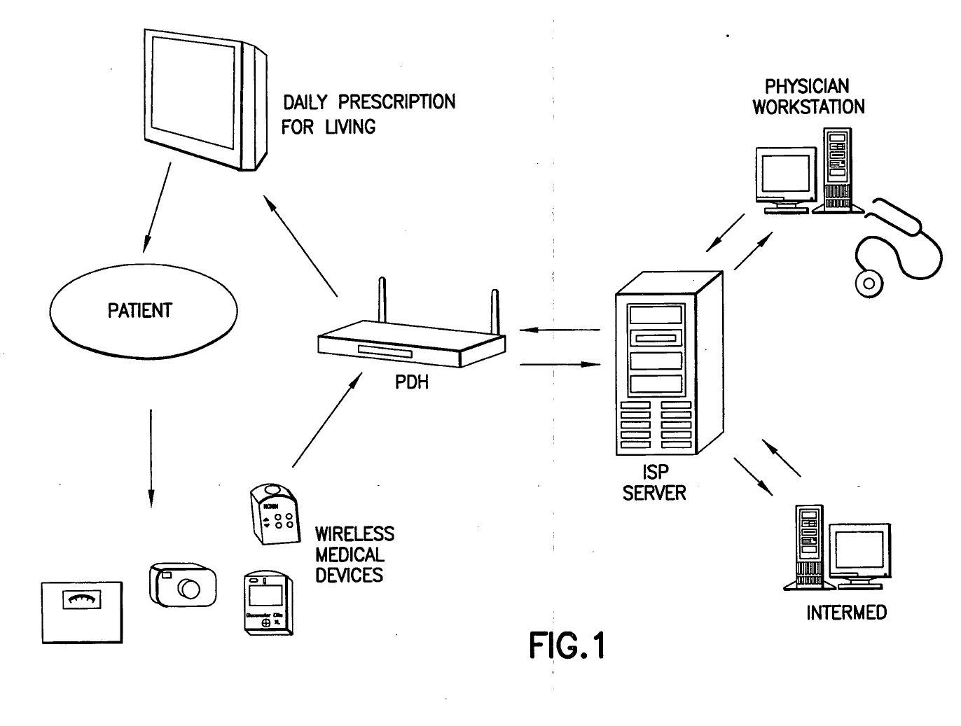

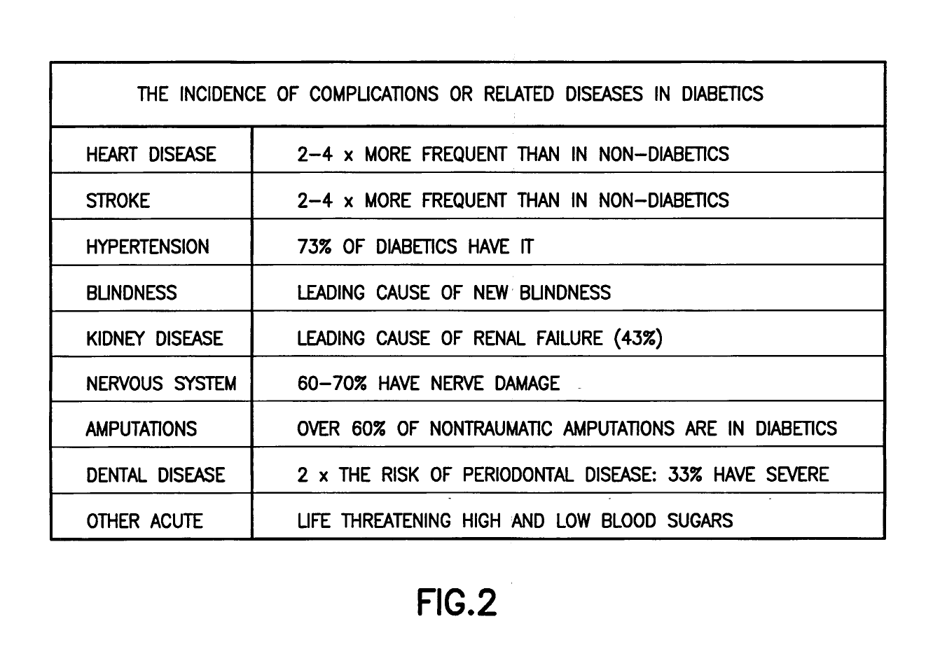

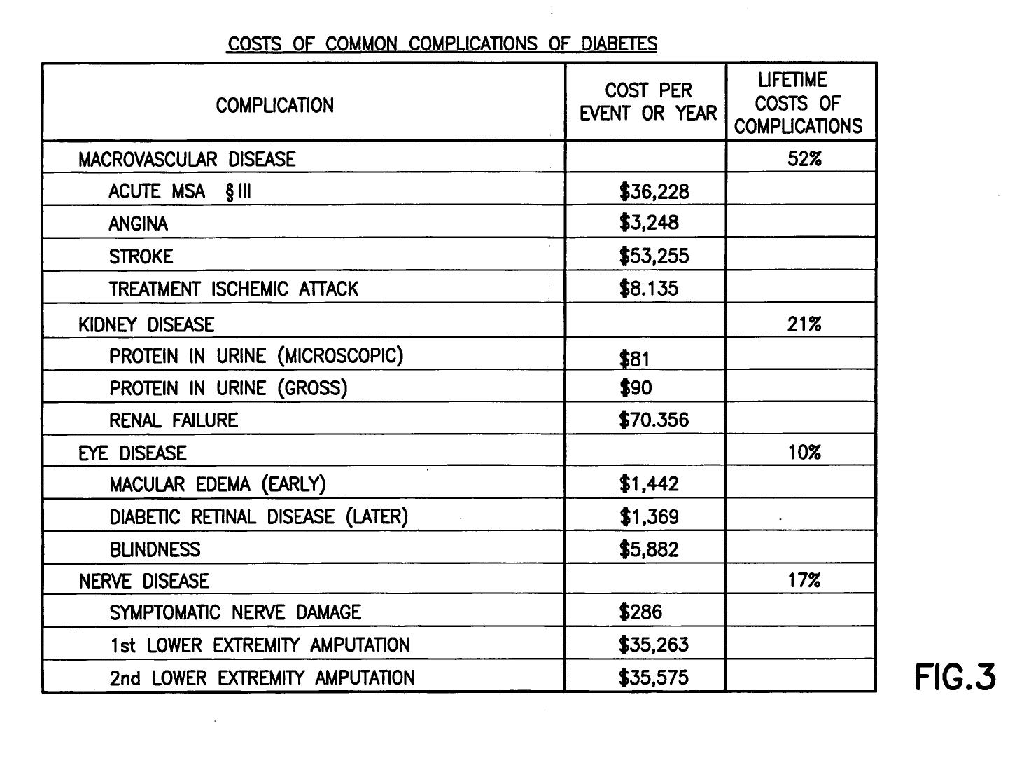

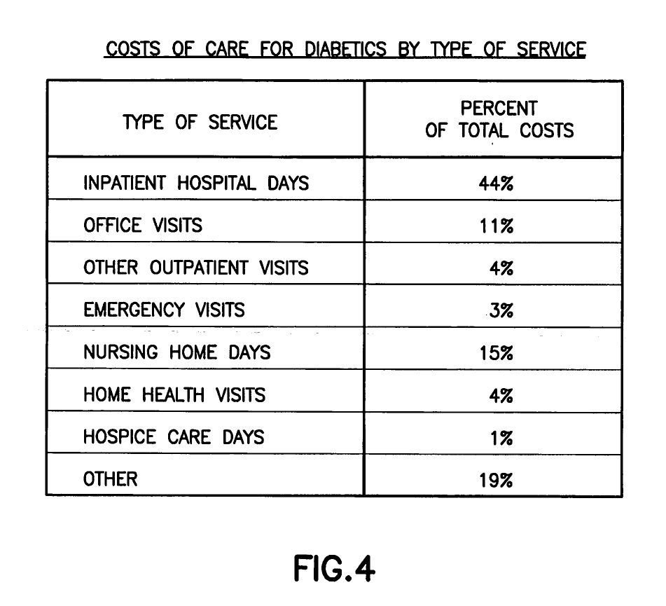

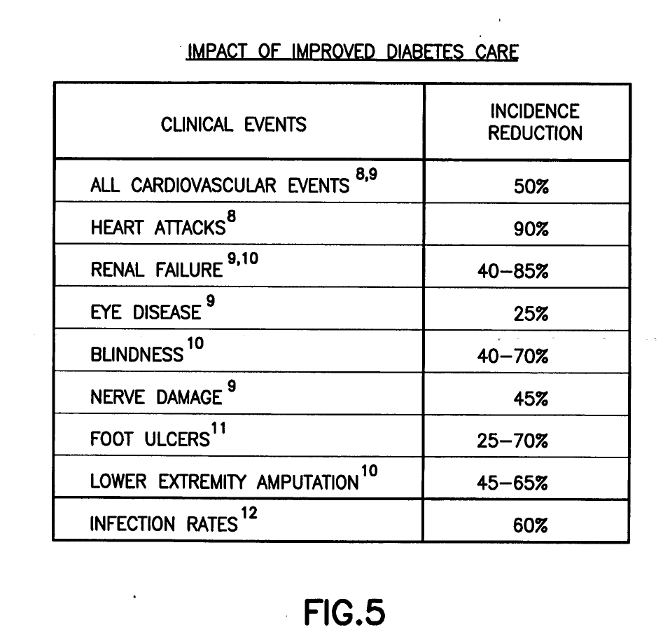

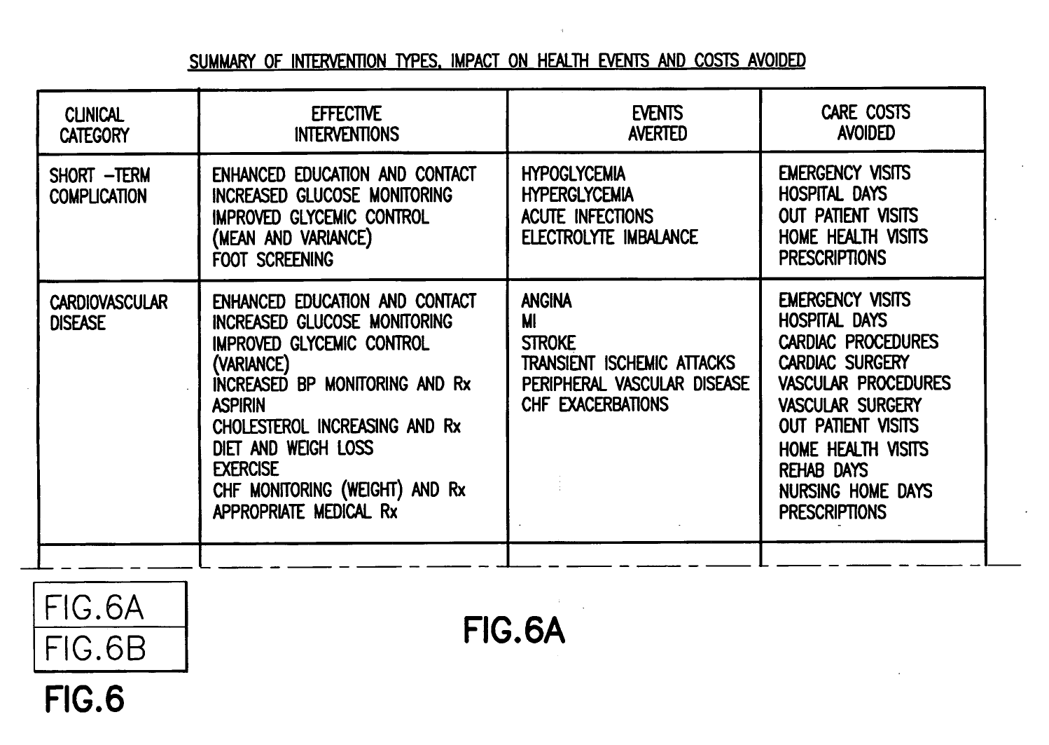

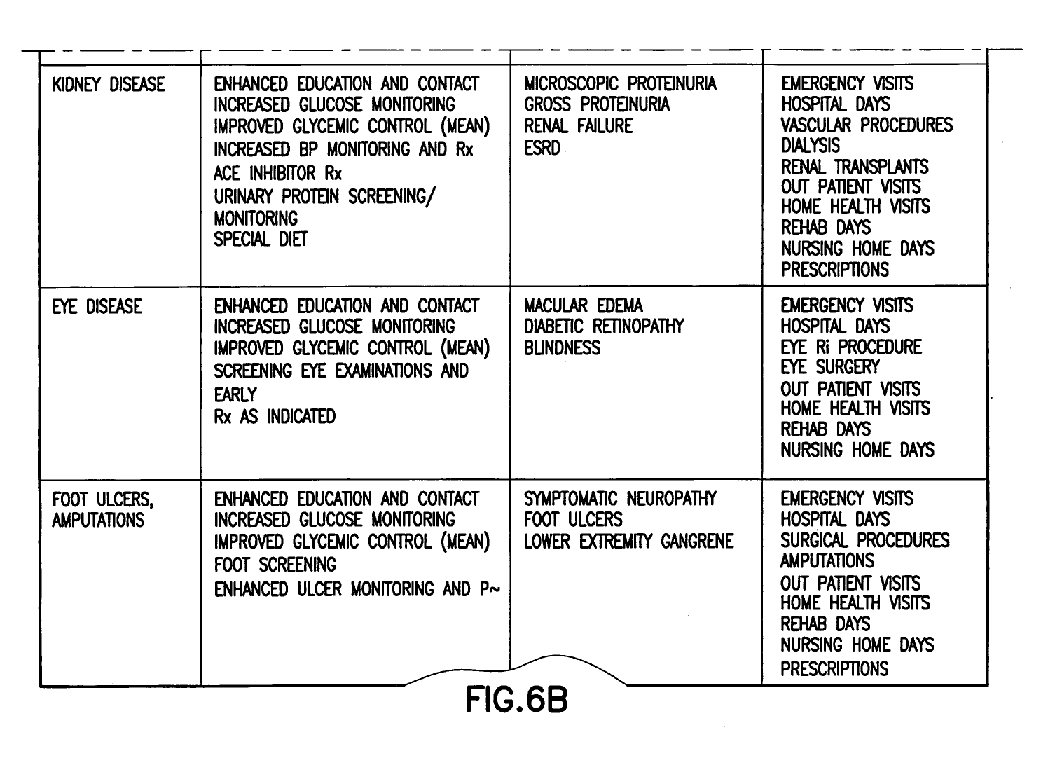

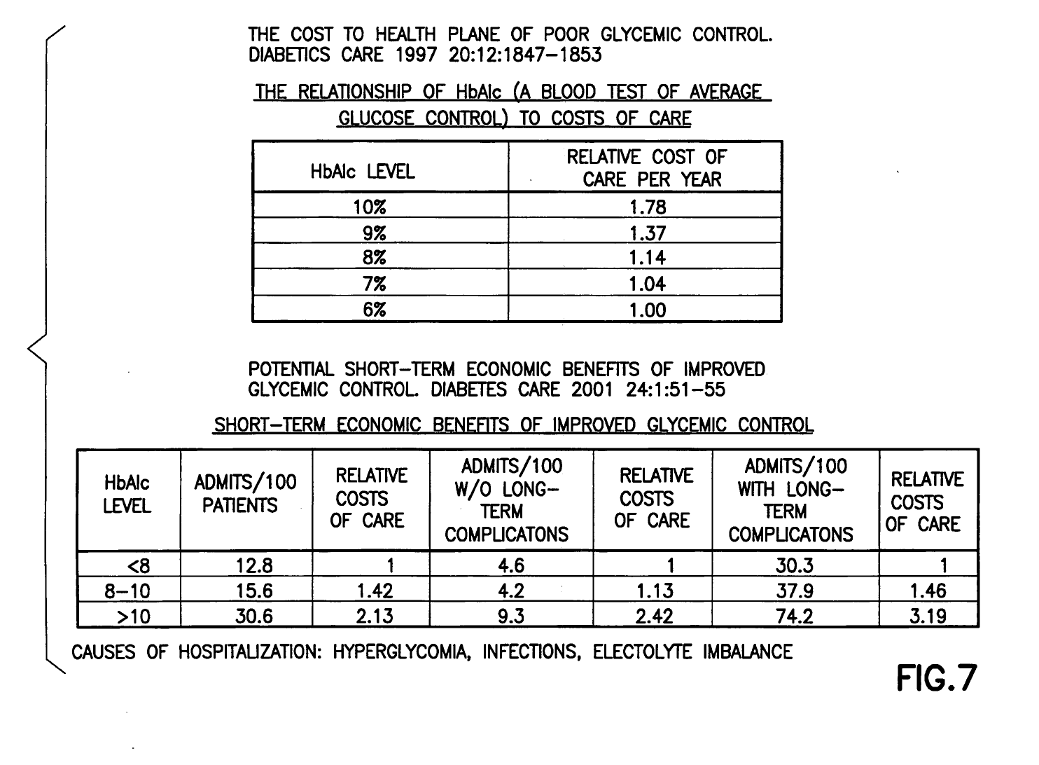

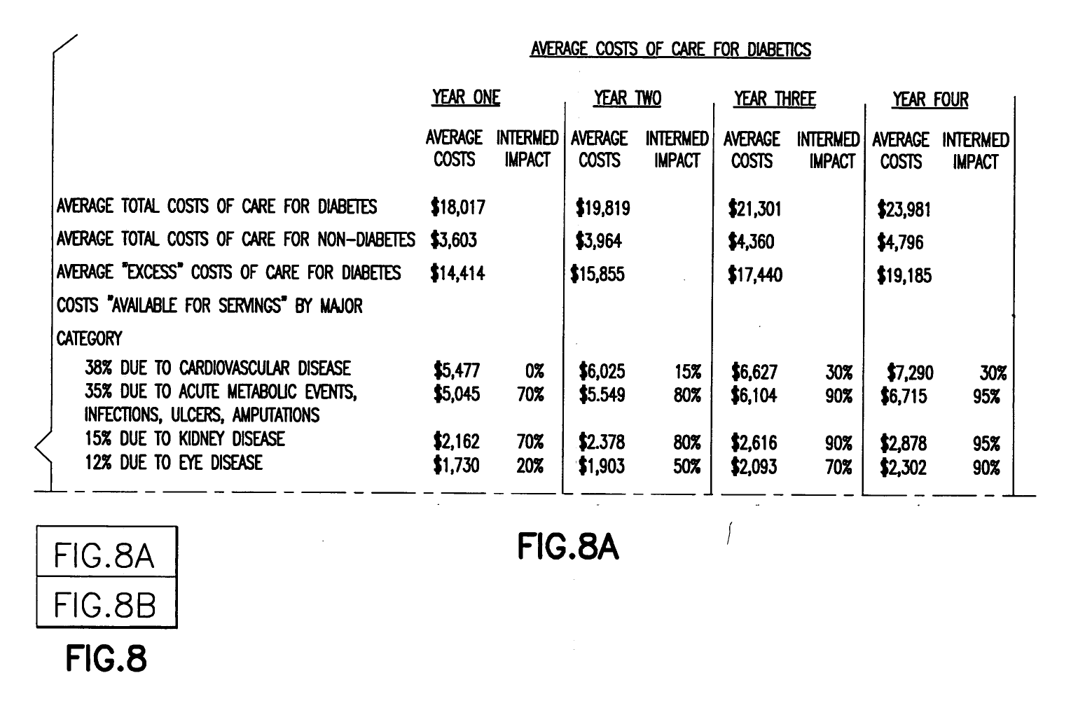

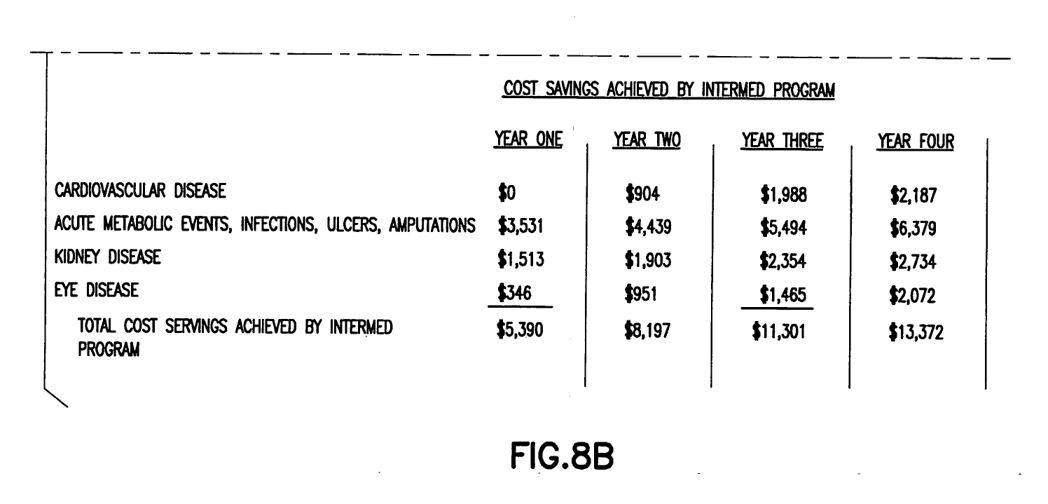

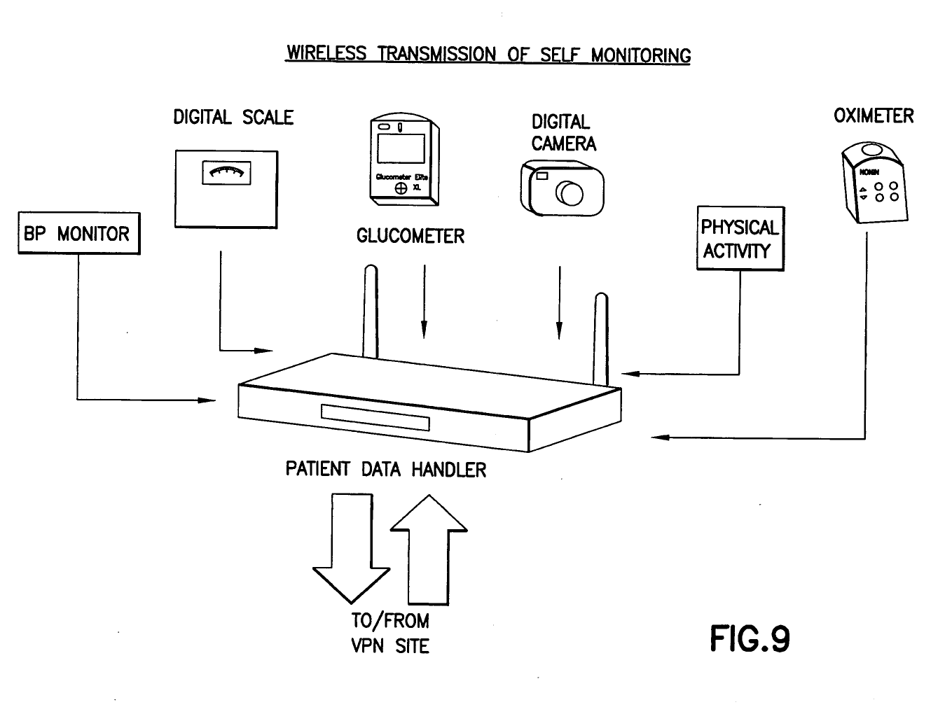

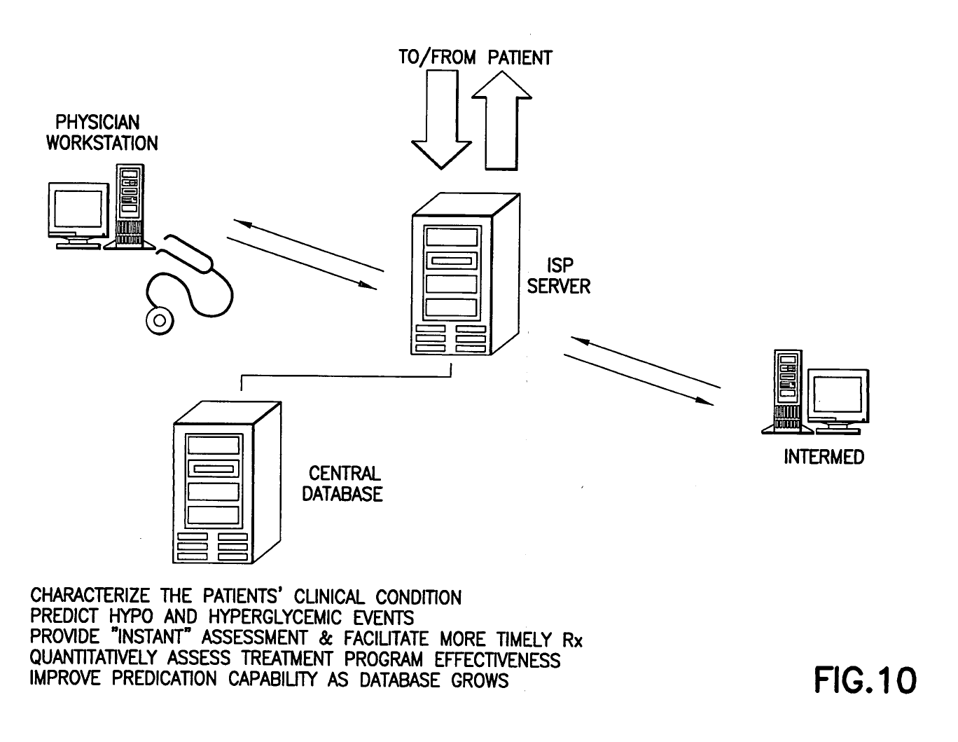

Referring now to FIGS. 1, 9 and 10, there are shown representations of a system/method according to various embodiments of the invention. In this regard, the invention may be set up to gather, transfer, store and/or analyze data. Input may be analyzed to notify patients and/or other users of the present invention of the most recent analysis and predictive modeling outcome. In one example the invention may include an input/output data managing device and a Private Network Center. The invention may be based on Internet computer architectures (or other communication technologies and/or devices) that provide multiple users access (such as worldwide access) to the invention through a number of Data Managing Devices supported by at least one central Private Network Center site/server computer. Of course, the invention can also be built within intranet or other types of closed system architectures.

In any case, a patient's initial input data (e.g., initial input data for a chronically ill patient) may be comprised of records of measurement, or combinations of records of measurements for various health related parameters relevant to that patient. Data may be entered into the invention through at least one input device (e.g., glucometer, blood pressure monitor, scale, oximeter, physical activity monitor and/or a digital camera). Data may comprise measurements of various parameters separated in time by a sequence of time intervals. Data may further include, but are not limited to, measurements of variables such as body fat percentage, electrocardiograms, stress tests, CBC (white blood count, red blood count, hemoglobin, hematocrit, MCV, MCH, MCHC, platelet count), BMP (sodium, potassium, chloride, bicarbonate, anion gap, glucose, BUN, creatinine), LFT (albumin, total and direct bilirubin alkaline phos, ALT/GPT, AST/GOT), HDL-P (cholesterol, triglyceride, HDL-cholesterol, LDL-cholesterol), Monotests, Iron, TIBC, % Sat, FT4, thyroxine, TSH, Total T3, T3 Uptake FTI, Ferritin, Vitamin B12, Folate, DHEA-F, CANCER AG 125-A, Luteinizing Hormone, FSH, Testosterone, Pros Spec Ag, various eye tests such as for Glaucoma, and other parameters.

In another embodiment, a user of the invention may have health record data input directly into the invention using other types of input devices, such as (but not limited to) keyboards, scanners, microphones, cameras, wireless and mobile devices, other computer systems, and through medical sensors and measuring devices. Examples of such medical sensors and measuring devices include, but are not limited to, thermometers, sphygmomanometers, and EKG machines. Data signals may include, but are not limited to, the results of blood tests, urine tests, and other medical tests.

In yet another embodiment, stored data relating to the measurements and other such input concerning patients (e.g., chronically ill patients) may be output by various output devices, including, but not limited to, printed sheets of paper output by printers, output by other devices such as facsimile machines, speech synthesizers, computers, and other devices.

Reference will now be made to various data sources which may be used in connection with the present invention. In one example (which example is intended to be illustrative and not restrictive), a user (such as a chronically ill patient) may be provided at least one device with which to generate time series data. Such device(s) may include (but are not limited to): a glucometer, blood pressure monitor, scale, oximeter, physical activity monitor, and/or a digital camera. In one example the user may take measurements according to a medical protocol using device(s) as would be essentially the same practice if the patient were subject to conventional care. In another example the user is not required to manually or otherwise record data (such as measurements) taken (the recording may be carried out automatically and transparently to the user, for example). The data may be transported by a means of communication (e.g., by wireless technology) to the Data Managing Device of the invention (discussed in more detail below).

In one embodiment, the invention may utilize data from at least three sources. In one example (which example is intended to be illustrative and not restrictive), the three sources may be as follows:

First Source. This first source may include user input and may generate data as follows (of course, the following measurements, methods and frequencies are intended to be illustrative and not restrictive):

| Measurement | Method | Frequency |
|---|---|---|
| Blood glucose level | Glucometer | 2-5times daily |
| Blood pressure | Blood pressure | 1 time daily |
| | monitor | |
| Weight | Scale | 1 time daily |
| Blood oxygen saturation | Oximeter | Irregular intervals |
| Visual lower extremity data | Digital camera | Weekly |
| Physical Activity | Physical Activity | Daily |
| | Monitor | |

Second Source. This second source may be developed when a patient's medical history is input (e.g., initially input) into the invention from a source of input data, such as the treating physician. Information required by the invention may updated (e.g., periodically) by such sources. When such patient data is initially input into the invention, a base point for the history of a patient may be generated, past test results may be incorporated and the patient's file may be reviewed by extrinsic sources for historical analysis and/or additional inputs. Future medical intervention data may be input into the invention as well.
Third Source. This third source of data may comprise pharmaceutical compliance/information and may be provided, for example, by the user's pharmacy, health plan, and/or pharmacy benefits manager (such data may be updated (e.g., periodically) by interviews and/or other means.

As mentioned above, the data source(s) may be used by various embodiments of the invention to generate individual patient time series (which can be looked at intrinsically and/or extrinsically). Further, various embodiments of the invention may provide independent analyses of data sources (e.g., facilitating examination of patient developments and assessment as well as patient progress in terms of control variables including variance control). Such management practices may be available through use of the analysis and predictive modeling of the invention.

In another example (which example is intended to be illustrative and not restrictive), multiple analyses of time series generated by the invention may generate links to assess patient treatment modalities. The extent to which the series are either: (1) correlated with one another by the invention; or (2) are uncorrelated with one another by the invention may provide useful therapeutic input. Further, data sets may be employed by use of systems identification techniques to facilitate contributions of particular treatment options in terms of exact management variable outcomes (and may result in both efficacy comparisons and patient specific cost effectiveness analyses).

Reference will now be made to a Data Managing Device (“DMD”) for managing the data about and/or provided by the user. In one example (which example is intended to be illustrative and not restrictive), the DMD may be compact and capable of placement in close proximity to the user (e.g., such as the patient's home or work). In another example (which example is intended to be illustrative and not restrictive), DMD may comprise a server apparatus. The DMD may collect data generated about and/or by the user (such data collection may be carried out wirelessly, for example) and the DMD may be connected to a means of media transmission/communication, such as the user's cable, land, or cellular telephone line—the DMD may, such as at periodic intervals, connect to the Private Network Center (“PNC”) to provide data thereto.

In this regard, the PNC may comprise the mechanism via which data analysis algorithms, calculations and/or predictive modeling processes are carried out. All relevant data may be recorded and stored at this site and may be analyzed and/or modeled (e.g., for changes in development and possible variance). Data and information may be integrated with lifestyle data as well as extrinsically generated information on the patient's medical treatment (e.g., to provide evaluation of progress by use of nonlinear analysis of time series combined with systems identification mathematics). In one example (which example is intended to be illustrative and not restrictive), data transmission and/or storage may be HIPAA compliant.

In another embodiment, a flow of information from a user to the PNC may be produced, as well as output (e.g., periodic output, such as hourly, daily, weekly or monthly) from the PNC to various independent and/or simultaneous users (access to the information may not necessarily be limited by time or number of concurrent users). Such output as may be available (e.g., from the PNC) may be provided in various forms (e.g., printed, audio, visual, such as on a computer monitor). Further, data may be sent by means of media transmission/communication, such as a telephone line, to a user's DMD for access. In one example (which example is intended to be illustrative and not restrictive), output is provided in a visual display, such as a computer monitor or wireless device screen, to provide user appreciation for the delivery of the output and feedback to the user (including, for example, advice for activities, recommendations for follow-up, changes in behavior when appropriate, and/or indications for physician contact when needed).

In another embodiment, the output may include a computer generated image to communicate with the user. Such output may sometimes be referred to herein as the “Virtual Companion” (e.g., a computer generated image that appears visually and delivers verbal presentation of periodic feedback). This presentation may help to motivate the user to continue use of the invention and encourage patient compliance with periodic patient needs (including such examples as opthamological visits and/or other medical or health care related follow-ups).

Thus, the invention may encourage compliance and participation by the user by varying the content of the output as appropriate. Further, at least one access point may be provided whereby a user can communicate with others (e.g., to aid understanding of the particular disease and/or treatment).

Reference will now be made to the following example models, algorithms and statistical evaluations which may be utilized in connection with various embodiments of the invention (e.g., in order to carry out the predictive modeling for a specific patient). Of note, such example models, algorithms and statistical evaluations are intended to be illustrative and not restrictive. Of further note, the names applied to these example models, algorithms and statistical evaluations are intended to include the techniques described herein when such names are utilized in the claims of the application.

1. Trend Detection Algorithm

The trend detection algorithm may comprise a series of calculations designed to detect whether a given time series shows signs of a significant upward trend, significant downward trend, or no trend within a given time window. The necessary input for this process is a time series of data, defined as any data Y₁ . . . Y_{T}, measured for time 1 . . . T where Y₁ represents the first data point and Y_{T} the data point at time T.

A. Linear Model

The linear model of this time series is described by:
Yₜ=β₀+β₁t+Eₜ (1)
where Eₜ is autocorrelated random noise, although that fact is unimportant in this version of trend detection. The coefficients β₀ and β₁ for this model are estimated using the method of ordinary least squares (OLS). The model calculates the best fitting straight line for the response data given, and the estimated coefficient, \hat{β}₁ can be tested if it is significantly different from zero by a standard test statistic

$$τ = \frac{{\hat{β}}_{1}}{\hat{s}}$$

where ŝ is the sample standard deviation given by the regression output. This test statistic τ is distributed according to the t-distribution, and the critical value for detecting trend may be set at ±1.96, corresponding to a 95% confidence level. A value above 1.96 would be indicative of a significant positive trend, a value below −1.96 would be indicative of a significant negative trend. Confidence levels may be adjusted, however, and the corresponding critical values would then change as appropriate.
B. Piece-Wise Linear Model

Another mechanism is to use an algorithm more robust in detection of non-linear monotonic trend. This algorithm may be as described in Fried and Imhoff, 2004. This method includes a piece-wise linear model in place of the linear model in equation (1) in order to better characterize non-linear trends. In addition, the autocorrelations Eₜ are modeled using an autoregressive (AR) model in order to determine the autocovariances used in the test statistic. Finally, “shrinkage estimates” are obtained using the procedures and formulas contained in the paper, in order to reduce the bias in estimators associated with piece-wise regression. Although the methods differ from the previous procedure, the output of the algorithm is still a test statistic, τ, that detects significant positive trend, significant negative trend, or no trend according to a specified probability distribution as described in the paper.

C. Pattern Recognition

A further mechanism to detect trend is to explicitly design possible “trend templates” and then determine if a given time series matches a trend exhibited in one of the templates. The templates may include linear or non-linear trend, monotonic or non-monotonic trend, and also a template for no trend (a straight line). One algorithm to determine a match between a given time series and any one template in a previously defined template library is described in Haimowitz et al (1995). The output of such an algorithm includes the most likely match for the trend observed in the time series among the trend templates and the estimated time point, k, where the trend is estimated to have begun.

2. Variance Detection Algorithms

These algorithms are used to detect changes in the variance of time series data. Increased variance of the data, for example, may be observed in readings towards the end of a time series fluctuating wildly, whereas earlier readings may be confined in a smaller range. Changes in variance may be considered separately from changes in trend; data from two periods may have the same average level, but different variances.

Before employing algorithms to search for a change in the variance of a time series, the series may need to be detrended and corrections for autocorrelation may need to be made. After detrending and correction for autocorrelation occurs, the residuals are then analyzed in order to detect change(s) in variance.

A. ARIMA Model

The detrending and correction for correlation for a time series of data, Z₁ . . . Z_{T}, may be done by using an ARIMA(p,d,q) model. This model is described by:
Yₜ=α₁Yₜ₋₁+ . . . +αₚYₜ₋ₚ+eₜ+β₁eₜ₋₁+ . . . +β_{q}e_{t-q}. (2)

Therefore, the “p” term designates the number of autoregressive components to include, or, in other words, the amount of time lag to include in the model. The “q” term specifies the number of moving average components, or the number of innovations to include. The “d” term specifies the order of differencing desired. If d=1, for instance, then Yₜ=Zₜ−Zₜ₋₁, Yₜ₋₁=Zₜ₋₁−Zₜ₋₂ and so on. If d=0, then {Y₁ . . . . Yₜ}={Z₁ . . . Zₜ}. Presumably, after detrending, the residuals would be centered at zero, so by detecting changes in the distribution of the residuals, the algorithm would essentially detect changes in the spread of the residuals, or, in other words, their variance.

The ARIMA model is a representation of a time series, and the method of its estimation may be accomplished by any standard statistical software package with time series capabilities. The parameters (p, d, q) may be set by the investigator according to prior information or input by an expert in the field, although an automated way to determine the best ARIMA model may be imagined. [QUERY: ARE ANY SPECIFICS OF SUCH AUTOMATION AVAILABLE?] In the capacity of variance change analysis, the object of the ARIMA model is to determined a set of residuals X₁ . . . Xₜ which have the property of being distributed independently and randomly with mean 0 and variances σₜ². These residuals are determined by taking the difference between the observation Yₜ and the model prediction Ŷₜ. Formally Xₜ=Yₜ−Ŷₜ (3).

B. D-Statistic Procedure

a. Definition of the Dₖ-statistic Let

$${C}_{k} = {\sum }_{t = 1}^{k} {X}_{t}^{2}$$

be the cumulative sum of squares of a series (CUSUM) of uncorrelated random variables X₁ . . . X_{T} with mean 0 and variances σₜ², t=1,2, . . . , T. Let

$${D}_{k} = \frac{{C}_{k}}{{C}_{T}} - \frac{k}{T} , k = 1 , … , T , with {D}_{0} = {D}_{T} = 0 \qquad ( 4 )$$

be the centered (and normalized) cumulative sum of squares.
b. Detection of a Single Change in Variance

The Dₖ-statistic allows for the detection of changes in variance of a series of uncorrelated random variables. Let k* be the value of k at which maxₖ|Dₖ| is attained. The time k* which maximizes the Dₖ-statistic is taken to be the most likely location for a change in variance. This point may be found if the variables X₁ . . . X_{T} are assumed to be distributed normally, with mean 0 and variances σₜ², t=1, . . . , T. The logarithm of the likelihood ratio for testing whether there is a change in that time period is

$$LR = - {max}_{k} \{ - \frac{k}{2} log ( 1 + \frac{T}{k} {D}_{k} ) - \frac{T - k}{2} log ( 1 - \frac{T}{T - k} {D}_{k} ) \} . \qquad ( 5 )$$

The value of k which maximizes the likelihood ratio in (5), or k*, is then used to calculate D_{k*}. For a fixed k, the value of Dₖ can be written as a function of the usual F-statistic for testing equality of variances between two independent samples. Specifically, consider the full set of variables X₁ . . . X_{T} as stated above. Let the first sample consist of observations Xᵢ, i=1, . . . , k*, with variance σₜ², and let the second sample be Xⱼ,j=k*+1, . . . , T, with variance σₜ². Then the F-statistic for testing the null-hypothesis
H₀: σ₀²=σ₁² against Hₐ: σ₀²<σ₁² is F_{T-k*,k*}=((C_{T}−C_{k*})/(T−k*))/(C_{k*}/k*).

Thus D_{k*} can be expressed in terms of F_{T-k*,k*} as

$${D}_{{k}^{*}} = \frac{{C}_{{k}^{*}}}{{C}_{T}} - \frac{{k}^{*}}{T} = \frac{{K}^{*} ( T - {k}^{*} )}{{T}^{2}} [ \frac{1 - {F}_{T - {k}^{*} , {k}^{*}}}{\frac{{k}^{*}}{T} + \frac{T - {k}^{*}}{T} {F}_{T - {k}^{*} , {k}^{*}}} ] \qquad ( 6 )$$

For a specific D_{k*}, F_{T-k*,k*} can be calculated, and the significance of the change in variance can be determined for the desired confidence level, usually 95%.

Other approaches using the CUSUM can also be employed. The D-statistic procedure outlined above should be considered to cover all of those procedures as well.

c. Detection of Multiple Changes Algorithm

In the case of a possible existence of a single point of change then the Dₖ function may be used. But when there may be multiple change points, an iterative algorithm should be employed based on successive applications of Dₖ to pieces of the series, dividing consecutively after a possible change point is found. An algorithm to perform such a procedure can be found, for example, in “Use of Cumulative Sums of Squares for Retrospective Detection of Changes of Variance” (Inclan and Tiao, Journal of the American Statistical Association, 1994).

C. A Non-Parametric Approach (Rank Statistic)

a. An alternative approach to using the cumulative sums of squares (CUSUM) to detect change in a sequence of random variables is to use non-parametric rank statistics. A sequence of continuous random variables, X₁ . . . Xₜ, is observed and one wants to detect whether a change in these variables has occurred in terms of their distribution at a time point τ. For this procedure, the distribution function(s) of these variables need not be known. Suppose R₁ . . . Rₜ are the ranks of the t observations X₁ . . . Xₜ in the complete sample of T observations. Define
   U_{t,T}=2Wₜ−t(T+1), (7)
   where Wₜ=ΣRⱼ summing over j from 1 to t. It should be noted that the distribution of U_{t,T} is symmetric around zero; large negative values indicate an increase in the mean, while large positive values indicate a change in the positive direction.

Following the procedures outlined in Pettitt (1971), one can then define distributional aspects of Wₜ, which leads to the construction of a test statistic, K_{T}, for the null hypothesis of no change. Define

$${K}_{T} = {max}_{1 \leq t < T} \vert {U}_{t , T} \vert . \qquad ( 8 )$$

One can then consider the significance probabilities associated with the values k of K_{T} as given by
p≅2exp{−6k²/(T³+T²)} (9)

By using these formulas, an investigator only needs the inputs X₁ . . . X_{T} in order to find the estimated time point \hat{τ} of the change and calculate its p-value, p. The rejection level for p may be set at any level, although a number less than 0.05 is customary for a declaration of statistical significance.

Because the observed variables X₁ . . . X_{T} may be drawn from any distribution, this algorithm may be used to analyze the uncorrelated residuals from a de-trended time series, as the distribution of these residuals may not be known. However, since the residuals should not display a trend (change in mean) over the course of time after detrending, if a change is detected in the distribution, then that indicates a change in variance, or an increase or decrease in the spread of the residuals over the range of possible values, has occurred.
b. A generalization of this test for change in variance may be made in order to detect multiple changes in the distribution of the variables. Such a generalization may be found in Meelis et al (1991), and is very similar to the detection of multiple changes algorithm used by Inclan and Tiao (1995) with the D-statistic as the test statistic.
   3. Prediction

The ability to predict values in a time series involves using any or all past and present information. Because the exact nature of the process generating these time series is often unknown, and may include complicating factors such as noise, various models exist in order to accomplish the prediction. Prediction falls under two categories. The first category, interpolation, involves predicting past values of the time series. The second category, extrapolation, involves predicting future values; this second category is also called forecasting. The models presented below may be used to accomplish both goals as appropriate.

A. General ARMAX Model

The general ARMAX(r, m, n) model is an ARMA model (as described in section 2A) with an additional set of covariates from “outside” the time series Y₁ . . . . Yₜ. The model is described as,

$${Y}_{t} = C + {\sum }_{i = 1}^{R} {α}_{i} {Y}_{t - i} + {ɛ}_{t} + {\sum }_{j = 1}^{M} {β}_{j} {ɛ}_{t - j} + {\sum }_{k = 1}^{N} {ϕ}_{k} X ( t , k ) \qquad ( 19 )$$

with autoregressive coefficients αᵢ, moving average coefficients βⱼ, innovations εₜ, and variable of interest Yₜ. X(t, k) is an explanatory regression matrix in which each column is a time series and X(t, k) denotes the tth row and kth column. The inputs into this model are the time series which is to be modeled, Y₁ . . . Yₜ and the one (or more) time series which are used as covariates, X(1 . . . t, 1 . . . k).

The parameters for this model may be estimated recursively by an algorithm which uses least squares, and may be performed by any standard statistical software package. Upon estimation of C, \hat{α}ᵢ, \hat{β}ⱼ and \hat{φ}ₖ, predictive interpolation of the data at any time point Ŷ may be calculated by equation (19). In addition, this equation allows extrapolative prediction of the next data point in the time series at t+1 by using the formula:

$${\hat{Y}}_{t + 1} = \hat{C} + {\sum }_{i = 1}^{R} {\hat{α}}_{i} {Y}_{t + 1 - i} + {\sum }_{j = 1}^{M} {\hat{β}}_{j} {ɛ}_{t + 1 - j} + {\sum }_{k = 1}^{N} {\hat{ϕ}}_{k} X ( t , k ) \qquad ( 20 )$$

The forecast can then be extended to the next h values by building off of the previously forecasted values by using (20).

B. GARCH

The GARCH (general autoregressive conditional heteroscedastic) model is used to model the variance of the time series data, as it may change over time. Say there exists data X₁ . . . X_{T} where Xₜ is distributed normally Xₜ˜N(0, hₜ). The GARCH(p, q) model describing this data is then:

$${h}_{t} = {α}_{0} + {\sum }_{i = 1}^{q} {α}_{i} {X}_{t - i}^{2} + {\sum }_{j = 1}^{p} {β}_{j} {h}_{t - j} , \qquad ( 21 )$$

with constraints α₀>0, αᵢ≧0, βⱼ≧0. The parameter “p” determines how many lag terms for the estimated variance of the observations will be included. The parameter “q” determines how many lag terms for the squared data observations will be included. The parameters (p, q) are usually set by the investigator according to prior information or input by an expert in the field, although an automated way to determine the best ARIMA model may be imagined. [QUERY: ARE ANY SPECIFICS OF SUCH AUTOMATION AVAILABLE?] The only input into the model is the time series, X₁ . . . Xₜ.

The parameters for this model may be estimated recursively using a standard statistical package. Upon estimation of \hat{α}₀, \hat{α}ᵢ, and \hat{β}ⱼ, predictive interpolation of the variances at every time point, ĥ, may be calculated by equation (21). In addition, this equation allows extrapolative prediction of the variance in the time period t+1 by using the formula:

$${\tilde{h}}_{t + 1} = {\hat{α}}_{0} + {\sum }_{i = 1}^{q} {\hat{α}}_{i} {X}_{t + 1 - i}^{2} + {\sum }_{j = 1}^{p} {\hat{β}}_{j} {\hat{h}}_{t + 1 - j} . \qquad ( 22 )$$

The forecast can then be extended to the next h values by building off of the previously forecasted values by using (22).

C. Kalman Filtering

The Kalman filter is designed to estimate the state Xₜ of a discrete, time-controlled process that is governed by the linear stochastic difference equation:
Xₜ=AXₜ₋₁+Bμₜ₋₁+ωₜ₋₁ (23)
with an unobservable measurement Zₜ that is
   Zₜ=HXₜ+νₜ (24)

The random variables ωₜ and νₜ represent the process and measurement noise, respectively, and they are assumed to be independent, white, and with normal probability distributions
p(ω)˜N(0, Q) (25)
p(ν)˜N(0, R) (26)

Here the process noise covariance Q and measurement noise error R matrices are assumed to be constant.

The estimate of the “true” state of the time series, \hat{X}ₜ, must be calculated using a recursive Kalman algorithm. The recursive Kalman algorithm has two parts. The first part is called the time update step, and the second is called the measurement update step. The equations are as follows:
Time update equations:
   Xₜ=A\hat{X}ₜ₋₁+Bμₜ₋₁ (27)
   \tilde{P}ₜ=APₜ₋₁A^{T}+Q (28)

A and B are from (1), while Q is from (3). Initial conditions, i.e. \hat{X}ₜ₋₁ and Pₜ₋₁ are from a test period of no less than, for example, thirty days of data.

Measurement Update Equations:
Kₜ=\tilde{P}ₜH^{T}(H\tilde{P}ₜH^{T}+R)⁻¹ (29)
\hat{X}ₜ=\hat{X}ₜ₋₁+Kₜ(Zₜ−H\hat{X}ₜ₋₁) (30)
Pₜ=(1−KₜH)\hat{P}ₜ (31)
The first task during the update step is to compute the “Kalman gain”, or Kₜ H. The next step is to obtain a state estimate \hat{X}ₜ from the observed value Zₜ and other estimated parameters. The last step is to obtain an estimate of the error covariance Pₜ. After this has been completed, the process restarts with the next time slice. Estimation of Q and R are to be done offline, and may be “tuned” in order to afford optimal filter performance, assuming they remain constant.

The only input into this algorithm is the observed time series, Z₁ . . . Zₜ. The output is an estimated filtered time series \hat{X}₁ . . . \hat{X}ₜ, with the “process noise” removed. In addition, the Kalman Filter allows for forecasting, by first computing:
\hat{X}ₜ₊₁=A\hat{X}ₜ+Bμₜ, (32)
And then using \hat{X}ₜ₊₁ to compute \hat{Z}ₜ₊₁ by using the equation:
\hat{Z}ₜ₊₁=H\hat{X}ₜ₊₁. (33)

The forecast can then be extended to the next h values by building off of the previously forecasted values by using (32+33).

D. Markov Models

A time series may also be modeled as a stochastic process, or a process where the future is conditionally dependent on the past and present. The simplest form of a stochastic process is a Markov chain of random variables. A Markov chain is defined as a collection of random variables {Xₜ} (where the index t runs through 0, 1 . . . ) having the property that, given the present, the future is conditionally independent of the past. In other words:
P(Xₜ=j|X₀=i₀,X₁=i₁, . . . Xₜ₋₁=iₜ₋₁)=P(Xₜ=j|Xₜ₋₁=iₜ₋₁) (34)

With this framework, a transition matrix may be constructed, based only on the observed data contained in a time series that summarizes the probabilities of transitioning from the present state to any other possible state within the distribution of X. The ij^{th} entry of the transition matrix T represents the probability of X at time t−1 in state i transitioning to state j in t, or P(Xₜ=j|Xₜ₋₁=iₜ₋₁):

$$T = \begin{matrix}{p}_{11} & {p}_{12} & ⋯ & {p}_{1 m} \\ {p}_{21} & ⋰ & & ⋮ \\ ⋮ & & ⋰ & ⋮ \\ {p}_{n 1} & ⋯ & ⋯ & {p}_{nm}\end{matrix} \qquad ( 35 )$$

Based on this framework and transition matrix, predictive computer simulations may be performed, including, but not limited to: calculating the probability of reaching a certain state in a certain amount of time, calculating the expected time to reach a certain state, and construction of probability distributions around those answers.

E. Random Walk Models

Another way to predict values in a time series is to use a random walk model. The random walk model assumes that at any time point t, the process can be described by:
Yₜ=Yₜ₋₁+α (36)
where Y is a random variable and α is an additive random variable. If Y is continuous, the process is called Brownian Motion. If α is non-zero, that indicates a constant trend in one direction; then the model is called a “random walk with drift”. The decision to include trend or not, and the constant used to represent that trend, may be made by the investigator. It is easy to imagine, however, an automated routine that determines the level of trend to include. For instance, linear trend may [QUERY: WHAT IS THE INTENDED EXAMPLE HERE?]

In practice the point wise forecast for Yₜ₊₁ is simply Yₜ or Yₜ plus some additive constant, □, if there is believed to be trend. Random walk models, however, allow for the ability to construct confidence intervals surrounding that forecast. The variance of the forecast error is estimated by the variance of the error in the prediction from time periods 1 . . . t, or Var(Y₁ . . . Yₜ). The one step prediction error is simply the difference between the actual value Y and its one step prediction Ŷ. After calculation of the estimated variance of the prediction error, \hat{σ}², confidence intervals are constructed for the forecast Ŷₜ₊₁ by defining the interval as Ŷₜ₊₁±1.96*\sqrt{\hat{σ}²} (37). An “n” step ahead forecast, or Ŷₜ₊ₙ has a confidence interval Ŷₜ₊₁±1.96*\sqrt{n\hat{σ}²}(38) so the confidence interval grows with increasing uncertainty.

F. Multilayer Neural Networks

Multilayer Neural Networks can be employed to implement non-linear models that are able to classify data. In this process the parameters governing the nonlinear mapping are learned at the same time as those governing the linear discriminant for classification. This eliminates the need to have prior knowledge of the nonlinearity present in the model. Below we outline the backpropagation algorithm for training a three-layer neural network. The process employs gradient descent in error and is a natural extension of the Least Mean Squares algorithm. Although this analysis is done for a special case it can readily be extended to much more general networks and training protocol.

a. Definition of a Three-Layer Network

A three-layer network consists of an input layer, a hidden layer, and an output layer, interconnected by modifiable weights. There is also often a bias unit connected to non-input units.

Let X be a d-dimensional vector of inputs.

An input vector is presented to the input layer, and the output of each input unit equals the corresponding component in the vector. Each hidden unit computes the weighted sum of its inputs to form its scalar net activation. In other words, the net activation is the inner product of the inputs with the weights at the hidden unit. If we denote the bias unit as w₀, we can then write:

$${net}_{j} = {\sum }_{i = 1}^{d} {x}_{i} {w}_{ji} + {w}_{j 0} = {\sum }_{i = 0}^{d} {x}_{i} {w}_{ji} ≡ {W}^{t} X .$$

The subscript i indexes units in the input layer, j in the hidden; wⱼᵢ denotes the input-to-hidden layer weights at the hidden unit j. Each hidden unit emits an output that that is a nonlinear function of its activation, f(netⱼ). So we can then write:
yⱼ=f(netⱼ).

Each output similarly computes its net activation based on the hidden unit signals as:

$${net}_{k} = {\sum }_{j = 1}^{nH} {y}_{j} {m}_{kj} + {m}_{k 0} = {\sum }_{j = 0}^{nH} {y}_{j} {m}_{kj} ≡ {M}^{t} Y ,$$

where the subscript k indexes the units in the output layer and n_{H} denotes the number of hidden units.

The output unit Zₖ is then computed through the nonlinear function of its net, emitting:
zₖ=g(netₖ).

The output zₖ is thus a function of the input feature vector X after undergoing multiple weightings and nonlinearities.

b. Backpropagation Algorithm

As in LMS, we consider the training error on a pattern to be the sum over output units of the squared difference between the desired output tₖ given by a teacher and the actual output zₖ:

$$J ( W ) ≡ \frac{1}{2} {\sum }_{k = 1}^{c} {( {t}_{k} - {z}_{k} )}^{2} = \frac{1}{2} {‖ T - Z ‖}^{2} ,$$

where T and Z are the target and network output vectors of length c, and W represents all the weights in the network.

The backpropagation learning rule is based on gradient descent. The weights are initialized with random values, and then they are changed in a direction that will reduce the error:

$$Δ W = - η \frac{\partial J}{\partial W} ,$$

where η is the learning rate, and merely indicates the relative size in the change of the weights. In component form this looks like:

$$Δ {w}_{pq} = - η \frac{\partial J}{\partial {w}_{pq}}$$

This gradient descent equation demands that we take a step in weight space that lowers the criterion function. The criterion function J cannot be negative, so learning will always eventually stop, except in pathological cases. The iterative algorithm requires taking a weight vector at iteration m and updating it as:
W(m+1)=W(m)+ΔW(m),
where m indexes the particular pattern presentation.

Evaluating Δw_{pq} for the three-layer net now involves using the chain rule for differentiation. Considering first the hidden-to-output weights writing:

$$\frac{\partial J}{\partial {m}_{kj}} = \frac{\partial J}{\partial {net}_{k}} \frac{\partial {net}_{k}}{\partial {m}_{kj}} = - {δ}_{k} \frac{\partial {net}_{k}}{\partial {m}_{kj}} ,$$

where the sensitivity of unit k is defined to be:

$${δ}_{k} = - \frac{\partial J}{\partial {net}_{k}} ,$$

and describes how the overall error changes with the unit's net activation. Assuming that the activation function is differentiable (which is a valid assumption because we choose the activation function), we differentiate and find that for an output unit,

$${δ}_{k} = - \frac{\partial J}{\partial {net}_{k}} = - \frac{\partial J}{\partial {z}_{k}} \frac{\partial {z}_{k}}{\partial {net}_{k}} = ( {t}_{k} - {z}_{k} ) {g}^{′} ( {net}_{k} ) .$$

If noting that the derivative:

$$\frac{\partial {net}_{k}}{\partial {m}_{kj}} = {y}_{j} ,$$

then writing the learning rule for the hidden-to-output weights:
Δmₖⱼ=ηδₖyⱼ=η(tₖ−zₖ)g′(netₖ)yⱼ.

Now looking at the learning rule for input-to-hidden units, again using the chain rule for differentiation, and calculate:

$$\frac{\partial J}{\partial {w}_{ji}} = \frac{\partial J}{\partial {y}_{j}} \frac{\partial {y}_{j}}{\partial {net}_{j}} \frac{\partial {net}_{j}}{\partial {w}_{ji}} .$$

The first term on the right-hand side involves all of the weights mₖⱼ, so is written as:

$$\begin{matrix}\frac{\partial J}{\partial {y}_{j}} = \frac{\partial }{\partial {y}_{j}} [ \frac{1}{2} {\sum }_{k = 1}^{c} {( {t}_{k} - {z}_{k} )}^{2} ] \\ = - {\sum }_{k = 1}^{c} ( {t}_{k} - {z}_{k} ) \frac{\partial {z}_{k}}{\partial {y}_{j}} \\ = - {\sum }_{k = 1}^{c} ( {t}_{k} - {z}_{k} ) \frac{\partial {z}_{k}}{\partial {net}_{k}} \frac{\partial {net}_{k}}{\partial {y}_{j}} \\ = - \sum ( {t}_{k} - {z}_{k} ) {g}^{′} ( {net}_{k} ) {w}_{kj} .\end{matrix}$$

Analogous to the differentiation of the hidden-to-output units, defining the sensitivity for hidden units as:

$${δ}_{j} ≡ {f}^{′} ( {net}_{j} ) {\sum }_{k = 1}^{c} {w}_{kj} {δ}_{k} .$$

Using the fact that the sensitivity at the hidden unit is simply the sum of the individual sensitivities at the output units weighted by the hidden-to-output weights mₖⱼ, all multiplied by f′(netⱼ), thus writing the learning rule for the input to hidden weights:

$$Δ {w}_{ji} = η {x}_{i} {δ}_{j} = η [ {\sum }_{k = 1}^{c} {w}_{kj} {δ}_{k} ] {f}^{′} ( {net}_{j} ) {x}_{i}$$

With the two learning rules found for each set of weights, we are left with defining a training protocol to implement the learning. Since we are concerned only with supervised learning and will not be working with prohibitive amounts of data, we will employ batch training, in which all patterns are presented to the network before learning takes place.

c. Batch Backpropagation

Initialize n_{H}, W, criterion for stopping θ, η, r←0.

Do r [symbol] r + 1

m [symbol] 0; Δwⱼᵢ [symbol] 0; Δmₖⱼ [symbol] 0
Do m [symbol] m + 1

X^{m} [symbol] select m^{th} input vector
Δwⱼᵢ [symbol] Δwⱼᵢ + ηxᵢδⱼ; Δmₖⱼ [symbol] Δmₖⱼ + ηδₖyⱼ

Until m=n_{H}
wⱼᵢ [symbol] wⱼᵢ + Δwⱼᵢ; mₖⱼ [symbol] mₖⱼ + Δmₖⱼ

Until ∥∇J(W)∥ < θ
Return W.

G. Extreme Value Analysis

The classification of time series data into the proper distributions is essential to determining the risk of extreme values. The process of determining this risk by fitting a distribution is referred to as Extreme Value Analysis. This is significant because extreme values often are associated with crisis states. Misclassification of data can lead to underestimation of the risk of reaching a crisis state.

Often the Normal distribution is assumed to be the underlying distribution for data. Because it has the property of being completely symmetric, this assumption leads to misleading conclusions about the behavior of data. Most physical data do not fit the symmetry of the Normal distribution, but rather are skewed positively or negatively because of some natural boundary to the data values (i.e. blood glucose must be positive). The approach of Extreme Value Analysis is to fit a distribution to the data that will capture its true shape so that a proper assessment of the risk can be made.

For blood glucose readings, for example, there are many distributions that fit the general shape of these readings (i.e. they have a lower limit and a large upper tail). These include, but are not limited to, the Gumbel, Gamma, log-Pearson, Weibull, and lognormal distributions. There are two steps to applying Extreme Value Analysis to blood glucose measurements, parameter fitting and goodness-of-fit testing. Parameter fitting finds the most likely parameters for a given distribution given all the data, and is done separately for different distributions. Goodness-of-fit testing tests how well the data fits each of the hypothesized distributions with the calculated parameters.

a. Parameter Fitting

There are many methods for parameter fitting, but, for example, we will focus on maximum-likelihood estimation. Maximum-likelihood estimation views the parameters as quantities whose values are fixed but unknown. The best estimate of their value is defined to be the one that maximizes the probability of obtaining the samples actually observed. In contrast, another procedure using Bayesian methods view the parameters as random variables having some known prior distribution. Observations of the samples then convert this to a posterior density, updating the estimate of the true values of the parameters. However, this procedure almost always produces essentially the same estimate as maximum-likelihood estimation, so we will not address it here.

Maximum-Likelihood

A set of n independent vectors comes from a set D of training samples. We assume that p(x|ω), where x∈D, has a known parametric form, and is therefore determined uniquely by the value of a parameter vector θ. Because the samples were drawn independently we have:

$$p ( D \vert θ ) = {\prod }_{k = 1}^{n} p ( {x}_{k} \vert θ ) .$$

We call p(D|θ) the likelihood of θ with respect to the set of samples. The maximum-likelihood estimate of θ is by definition the value \hat{θ} that maximizes p(D|θ). If p(D|θ) is well-behaved and differentiable this can be found by the standard methods of differential calculus. For analytical purposes, it is often easier to work with the logarithm of the likelihood than the likelihood itself. Because the logarithm is monotonically increasing, the \hat{θ} that maximizes the log-likelihood also maximizes the likelihood.

b. Goodness-of-Fit Testing

The chi-square goodness-of-fit test is used to test if a sample of data came from a population with a specific distribution. The chi-square goodness-of-fit test is applied to binned data (i.e., data put into classes). This is actually not a restriction since for non-binned data you can simply calculate a histogram or frequency table before generating the chi-square test. However, the value of the chi-square test statistic is dependent on how the data is binned. We shall therefore first use Lloyd's Algorithm to find an optimal binning based on the number of samples and the sample values. For information on Lloyd's algorithm see “Least-Squares Quantization in PCM”, (Lloyd, IEEE Transactions on Information Theory 28 (2): 129-137 1982).

Chi-Squared Goodness-of-Fit

The chi-square test is defined for the hypothesis that the data follow a specified distribution. For computation of the test statistic, the data is divided into k bins and the test statistic is defined as:

$${χ}^{2} = {\sum }_{i = 1}^{k} {( {O}_{i} - {E}_{i} )}^{2} / {E}_{i} ,$$

where Oᵢ is the observed frequency for bin i and Eᵢ is the expected frequency for bin i. The expected frequency is calculated by Eᵢ=n(F(Yᵤ)−F(Yₗ)) where F is the cumulative distribution function for the distribution being tested, Yᵤ is the upper limit for class i, Yₗ is the lower limit for class i, and n is the sample size.

The test statistic follows, approximately, a chi-square distribution with (k-c) degrees of freedom where k is the number of bins and c is the number of estimated parameters (including location and scale parameters and shape parameters) for the distribution, plus one. For example (which example is intended to be illustrative and not restrictive), for a 3-parameter Weibull distribution, c=4.

Therefore, the hypothesis that the data are from a population with the specified distribution is rejected if:
χ²>χ_{(a,k-c)}²
where χ_{(a,k-c)}² is the chi-square percent point function with (k-c) degrees of freedom, and the significance level is α.
4. Risk Scoring Functions—Probit, logit. Population based. Extrinsic [QUERY: IS ANY MORE INFORMATION ON THESE RISK SCORING FUNCTIONS AVAILABLE?]

In another embodiment of the invention, mathematical analysis results in descriptive output based on sophisticated analysis of a patient's data (e.g., a chronically ill patient's data). In one example, predictive modeling descriptive output is transferred via a means for media transmission/communication to the DMD for access by the user. In yet another embodiment, output generated by the predictive modeling of the invention may consist of a visual display providing feedback to a patient which may include (but is not limited to) advice for physical activity, recommendations for follow-up treatment, changes in behavior when appropriate and/or healthcare provider contact when needed (e.g., opthamological visits and medical follow-ups).

The predictive modeling may provide output to numerous sources, such as to a patient and/or physician. Interactive dialogue is possible between various input and output sources. Data input into the invention may be organized and analyzed on a sophisticated analytical basis.

Various embodiments of the invention may be non-patient dependent, provide data transmission, facilitate patient compliance and/or provide real time data for real time interventions (e.g., in chronically ill patient care). The invention may provide all-accessible periodic feedback to numerous output locations based on the dynamic algorithms and predictive modeling results.

Improving care of chronically ill patients may reduce complexity of treating chronic illnesses by disaggregating chronically ill patient data and identifying through predictive modeling the specific form of the chronic illness which will individually characterize a chronically ill patient. The invention may utilize individual patient data to generate decision tools which are quantitatively employed to ameliorate problems for the chronically ill patient or other users of the invention. The invention may identify the basis for analysis which is suitable for an individual patient and compare the method most appropriate for that chronically ill patient with the traditional statistical approach. Such comparison may isolate the magnitude of the benefit associated with the correct tool. Such comparison may provide unique output to several sources, such as a physician, who may determine the care to employ for a certain chronically ill patient.

In another embodiment the invention may perform statistical analysis testing of the generic basis for prediction. The predictive models of the invention may be based on an appropriate generating function and may be used to control the potential for catastrophic medical events. After a certain period of time, sufficient data may be generated by the invention to improve the statistical foundation and to update decision rubrics. Estimates may be continually updated, intrinsically utilizing the data. As multiple time series are available, extrinsic analysis (i.e. relating one time series to another) is possible and the efficacy of treatment protocols can be ascertained.

As mentioned above, in one embodiment of the invention the technology is capable of generating data without need for wire-tied or encumbering devices, allowing generation of data to take place in the patient's home, office, or while traveling, without requiring the patient or caretaker to manually enter the data—freeing the patient with chronic disease from obligations associated with data transmission. The data generated may be input without need for direct physical connection (e.g., wirelessly to a DMD and/or PNC). Within the PNC, for example, a series of mathematical, statistical and/or modeling procedures may be utilized to assemble information regarding the patient's current and predicted health status from the patient's data.

In this regard, reference will now be made to the following examples of the application of various ones of the above-described models, algorithms and statistical evaluations to patient data collection and monitoring. Of note, such application examples are intended to be illustrative and not restrictive.

1. Trend Analysis

In this example the analysis of trend may be performed for four measurements: blood glucose, blood pressure, physical activity and weight. This analysis may be accomplished by modeling the trend as linear, as in section 1A, above. This trend detection may be performed, for example, on t consecutive days of blood glucose data collected before breakfast. Call this data X₁ . . . Xₜ. This data is the only input into the model described in equation (1). The output from the algorithm will be a test statistic, τ, which is distributed according to the t probability distribution, a well known and studied statistical distribution. If τ is above the critical value 1.96, which corresponds to a 95% confidence level, then there is considered to be “significant” evidence of trend within the past t days for the patient's blood glucose level at breakfast. This test of significance may be performed automatically according to pre-determined confidence thresholds. Ultimately, the output would then be a number, for instance (−1, 0, 1), which indicates significant negative trend, no significant trend, or significant positive trend respectively.

The trend may also (or alternatively) be detected using the algorithm described in section 1B, above, namely the one used by Fried and Imhoff, to model the trend as piece-wise linear. This trend detection may be performed, for example, on t consecutive days of blood glucose data collected before breakfast. Call this data X₁ . . . . Xₜ. This data is the only input into the model. The number of “pieces” in the model, k, will be determined by the investigator. The output from the algorithm will be a test statistic, τ, which is distributed according to the probability table described in the paper by Fried and Imhoff. If τ is above the critical value which corresponds to a 95% confidence level, then there is considered to be “significant” evidence of trend within the past t days for the patient's blood glucose level at breakfast. This test of significance may be performed automatically according to pre-determined confidence thresholds. Ultimately, the output would then be a number, for instance (−1, 0, 1), which indicates significant negative trend, no significant trend, or significant positive trend respectively.

The trend may also (or alternatively) be detected by using a pattern recognition algorithm as described in Section 1C, above. This trend detection may be performed, for example, on t consecutive days of blood glucose data collected before breakfast. Call this data X₁ . . . Xₜ. This data is the only input into the model. The trend templates, describing possible linear monotonic, non-linear monotonic, linear non-monotonic, non-linear non-monotonic trends, as well as one indicating no trend will have been pre-created by expert investigators and each will be assigned a number. The output from the algorithm will be the number signifying the most likely template. If the template chosen is not the template signifying no trend, then there is considered to be “significant” evidence of trend within the past t days for the patient's blood glucose level at breakfast. This test of significance may be performed automatically according to pre-determined confidence thresholds. Ultimately, the output would then be a number, for instance (−1, 0, 1), which indicates significant negative trend, no significant trend, or significant positive trend respectively.

In any case (i.e., regardless of the trend detecting algorithm used), the output of the algorithm would then be used to create a result for the patient. Continuing the blood glucose example, if the output of the algorithm for the past t days of data on pre-breakfast blood glucose indicates significant positive trend, then a flag would automatically be raised for this patient within the system (e.g., on the day in which the trend is reported).

This process may be used for any input including, but not limited to, blood glucose measured pre or post lunch, pre or post dinner, bedtime, or according to the daily mean; blood pressure (systolic and/or diastolic); physical activity; and/or weight. The possible outputs, indicating significant negative trend, no significant trend, or significant positive trend, may also be the same for some or all of the aforementioned inputs, and may be determined by the same test statistic and probability distribution. Moreover, the time “window”, 1 . . . T, may include any length of time (e.g., larger than thirty data points).

Of note, the analysis of trend of any or all of the listed inputs may be used in reports and other forms of communication to one or more of (but not limited to) the following parties: the patient's physician, the patient's caregiver, and/or the patient. Such reports may include (but not be limited to):

A. Physical Activity

Physician Report: The outcome of the trend analysis for physical activity may be used in charts, graphs, and/or textual reports generated by the system to be viewed by the physician in order to better inform them as to the status of the patient. Consecutive time periods of negative trend may also be used to generate alerts suggesting the physician to take immediate action regarding the patient.

Caregiver Report: This content may be similar to the physician report, including charts, graphs and/or textual reports, but tailored specifically to the preferences of the caregiver in order to improve their interaction with the patient. Alerts based on consecutive periods of negative trend may also be sent to the caregiver.

Patient Report: The patient report may include all of the content given to the physician and caregiver upon request by the patient. In addition, analysis may result in automatic generation of motivational or congratulatory content, suggestions, and/or queries that could include interactive components.

B. Weight

Physician Report: The outcome of the trend analysis for weight may be used in charts, graphs, and/or textual reports generated by the system. In one example, consecutive time periods of positive trend (i.e. gain in weight) may also be used to generate alerts.

Caregiver Report: This content may be similar to the physician report, including charts, graphs and/or textual reports, but tailored specifically to the preferences of the caregiver. In one example, alerts based on consecutive periods of positive trend (i.e. gain in weight) may also be sent to the caregiver.

Patient Report: The patient report may include all of the content given to the physician and caregiver upon request by the patient. In addition, analysis may result in automatic generation of motivational or congratulatory content, suggestions, and/or queries that could include interactive components.

C. Blood Pressure

Physician Report: The outcome of the trend analysis for blood pressure may be used in charts, graphs, and/or textual reports generated by the system. Trend analysis may be able to drive content and alerts based on various permutations of systolic and diastolic trending upward, downward or no change. Such analysis may also contribute to the body of knowledge driving changes in the patient's medication and/or other treatment regimen by the physician.

Caregiver Report: This content may be similar to the physician report, including charts, graphs and/or textual reports, but tailored specifically to the preferences of the caregiver. Trend analysis may be able to drive content and alerts based on various permutations of systolic and diastolic trending upward, downward or no change.

Patient Report: The patient report may include all of the content given to the physician and caregiver upon request by the patient. In addition, analysis may result in automatic generation of motivational or congratulatory content, suggestions, and/or queries that could include interactive components.

D. Glucose

Physician Report: The outcome of the trend analysis for glucose may be used in charts, graphs, and/or textual reports generated by the system. Trend analysis may be able to drive content and alerts based on various permutations of measurements such as pre and post breakfast, pre and post lunch, pre and post dinner, bedtime, and daily average. Such analysis may also contribute to the body of knowledge driving changes in the patient's medication and/or other treatment regimen by the physician.

Caregiver Report: This content may be similar to the physician report, including charts, graphs and/or textual reports, but tailored specifically to the preferences of the caregiver. Trend analysis may be able to drive content and alerts based on various permutations of measurements such as pre and post breakfast, pre and post lunch, pre and post dinner, bedtime, and daily average.

Patient Report: The patient report may include all of the content given to the physician and caregiver upon request by the patient. In addition, analysis may result in automatic generation of motivational or congratulatory content, suggestions, and/or queries that could include interactive components.

2. Detection of Change in Variance

In this example the detection of change in variance can be performed for blood glucose or blood pressure time series. The time series for either measurement may be detrended and corrected for auto-correlation using the ARIMA model described in Section 2A, above. The residuals from this model, described in equation (3) are then used as the inputs into the algorithms to detect a change in variance. This modeling may be performed, for example, on t consecutive days of blood glucose data collected before breakfast. Call this data Z₁ . . . Zₜ. This data is the only input into the ARIMA(p, d, q) model. Parameters (p, d, q) are determined based on a prior population based analysis. In another embodiment, parameters (p, d, q) are determined by an expert in the field of diabetes and/or hypertension. In another embodiment, parameters (p, d, q) are determined automatically by a search algorithm to find the most efficient values. The output from the algorithm is a series of data X₁ . . . Xₜ representing the uncorrelated and detrended residuals.

The data X₁ . . . Xₜ is then used as input into the variance detection algorithm. In one embodiment, the analysis to detect either single changes or multiple changes is accomplished by the change in variance detection algorithm described in Section 2B, above. The output from the algorithm will be a test statistic, T, which is distributed according to the F probability distribution, a well known and studied statistical distribution. If T is above the critical value that corresponds to a 95% confidence level and the appropriate degrees of freedom, then there is considered to be “significant” evidence of variance change within the past t days for the patient's blood glucose level at breakfast. This test of significance may be performed automatically according to pre-determined confidence thresholds. Ultimately, one aspect of the output would then be a number, for instance (−1, 0, 1), which indicates a significant decrease in variance, no significant change in variance, or significant increase in variance respectively. The second aspect of the output would be the value k* indicating the most likely time of the change of variance within the time period between 1 and t.

Also (or alternatively), single or multiple changes of the variance may be detected using the algorithm described in Section 2C, above, which utilizes a non-parametric statistic. The output from the algorithm will be a test statistic, K_{T}. The significance of this statistic, given by the value p, may be calculated using the formula given by equation (9). If p is below 0.05 then there is considered to be “significant” evidence of variance change within the past t days for the patient's blood glucose level at breakfast. This test of significance may be performed automatically according to pre-determined confidence thresholds. Ultimately, one aspect of the output would then be a number, for instance (−1, 0, 1), which indicates a significant decrease in variance, no significant change in variance, or significant increase in variance respectively. The second aspect of the output would be the value \hat{τ} indicating the most likely time of the change of variance within the time period between 1 and t.

In any case (i.e., regardless of the variance detecting algorithm used), the output of the algorithm would then be used to create a result for the patient. Continuing the blood glucose example, if the output of the algorithm for the past t days of data on pre-breakfast blood glucose indicates a significant change in variance, then a flag would automatically be raised for this patient within the system on the day in which the variance change is reported, and/or the day in which the variance change is estimated to have happened, i.e. k* or \hat{τ}.

This process may be used for any input including, but not limited to, blood glucose measured pre or post lunch, pre or post dinner, bedtime, or according to the daily mean; or blood pressure (systolic and/or diastolic). The possible outputs, indicating significant decrease in variance, no change in variance, or significant increase in variance, may also be the same for some or all of the aforementioned inputs, and would be determined by the same test statistic and probability distribution. Moreover, the time “window”, 1 . . . T, may include any length of time (e.g., larger than thirty data points).

Of note, the detection of change in variance of any or all of the listed inputs may be used in reports and other forms of communication to one or more of (but not limited to) the following parties: the patient's physician, the patient's caregiver, and/or the patient. Such reports may include (but not be limited to):

A. Blood Pressure

Physician Report: The outcome of the variance change detection algorithm for blood pressure may be used in charts, graphs, and/or textual reports generated by the system. Variance change analysis may be able to drive content and alerts based on various permutations of systolic and/or diastolic readings changing upward, downward or not changing. Such analysis may also contribute to the body of knowledge driving changes in the patient's medication and/or other treatment regimen by the physician.

Caregiver Report: This content will be similar to the physician report, including charts, graphs and/or textual reports, but tailored specifically to the preferences of the caregiver. Variance change analysis may be able to drive content and alerts based on various permutations of systolic and/or diastolic readings changing upward, downward or not changing.

Patient Report: The patient report may include all of the content given to the physician and caregiver upon request by the patient. In addition, analysis may result in automatic generation of motivational or congratulatory content, suggestions, and/or queries that could include interactive components.

B. Glucose

Physician Report: The outcome of the variance change detection algorithm for glucose may be used in charts, graphs, and/or textual reports generated by the system. Variance change analysis may be able to drive content and alerts based on various permutations of outcomes for measurements for pre and post breakfast, pre and post lunch, pre and post dinner, bedtime, and/or daily average. Such analysis may also contribute to the body of knowledge driving changes in the patient's medication and/or other treatment regimen by the physician.

Caregiver Report: This content will be similar to the physician report, including charts, graphs and/or textual reports, but tailored specifically to the preferences of the caregiver. Variance change analysis may be able to drive content and alerts based on various permutations of outcomes for measurements pre and post breakfast, pre and post lunch, pre and post dinner, bedtime, and/or daily average.

Patient Report: The patient report may include all of the content given to the physician and caregiver upon request by the patient. In addition, analysis may result in automatic generation of motivational or congratulatory content, suggestions, and/or queries that could include interactive components.

3. Prediction

In this example the forecasting of future values can be performed for blood glucose or blood pressure time series. The time series for either measurement may be predicted using the methods in Section 3A, above. This forecasting may be performed, for example, on t consecutive days of blood glucose data collected before breakfast. Call this data Y₁ . . . Yₜ. Also assume there is data on other measurements including: blood glucose measured pre or post lunch, pre or post dinner, and bedtime; blood pressure, both systolic and diastolic; physical activity; and weight. Make this into the data matrix X(t, k), where in this example k=9, because there are 9 additional time series. This data is the input into the ARMAX(r, m, n) model. In one example, parameters (r, m, n) are determined based on a prior population based analysis. In another example, parameters (r, m, n) are determined by an expert in the field of diabetes and/or hypertension. In another example, parameters (r, m, n) are determined automatically by a search algorithm to find the most efficient values. The output from the algorithm is a series of data Ŷₜ₊₁ . . . Ŷₜ₊ₕ representing the first h forecasts.

Also (or alternatively), the time series for either measurement may be forecasted using the methods in Section 3B, above. Before the GARCH model is used, however, the inputs into the model, X₁ . . . Xₜ, must be distributed approximately normal with zero mean, but with variances possibly differing in time. In one example, this type of series may be created from the measurements for blood glucose or blood pressure, by detrending and correcting for auto-correlation using the ARIMA model described in Section 2A, above. The residuals from this model, described in equation (3) are then used as the inputs into the GARCH(p, q) model. This forecasting may be performed, for example, on t consecutive days of blood glucose data collected before breakfast. Call this data Z₁ . . . Zₜ. This data is the only input into the ARIMA(P, d, q) model. Parameters (p, d, q) are determined based on a prior population based analysis. In another example, parameters (p, d, q) are determined by an expert in the field of diabetes and/or hypertension. In another example, parameters (p, d, q) are determined automatically by a search algorithm to find the most efficient values. The output from the algorithm is a series of data X₁ . . . Xₜ representing the uncorrelated and detrended residuals that should be distributed normally with zero mean. The data X₁ . . . Xₜ is then used as input into the GARCH(p, q) model described in Section 3B, above, (the parameters p and q may be different than those used in the ARIMA(p, d, q) model). The output from the algorithm is a series of data \hat{X}ₜ₊₁ . . . \hat{X}ₜ₊ₕ representing the first h forecasts for the detrended series. These values may be added to previously modeled trend in order to generate forecasts for Zₜ₊ₕ representing the next h days readings for pre-breakfast blood glucose readings.

Also (or alternatively), forecasting may be done using the formulas for the Kalman Filter contained in Section 3C, above. This forecasting may be performed, for example, on t consecutive days of blood glucose data collected before breakfast. Call this data Y₁ . . . . Yₜ. Also assume there is data on other measurements including: blood glucose measured pre or post lunch, pre or post dinner, and bedtime; blood pressure, both systolic and diastolic; physical activity; and weight. This data may be included in the matrix □ₜ, which takes into account possible external factors. This data is the input into the Kalman Filter model. The output from the algorithm is a series of data Ŷₜ₊₁ . . . Ŷₜ₊ₕ representing the first h days forecasts for the patient's pre-breakfast blood glucose reading.

Also (or alternatively), forecasting may be done using computer simulation procedures based on the Markov Process Model described in Section 3D, above. This forecasting may be performed, for example, on t consecutive days of blood glucose data collected before breakfast. Call this data Y₁ . . . . Yₜ. This data may then be classified into “bins” representing different levels of blood glucose. There may be defined k bins, each containing an equal range of possible blood glucose values. These bins may represent the state of the patient's blood glucose. The estimated probability of transferring from state j to state j+1,j to j+2 and so on may be calculated, and a transition matrix may be constructed from the observed data. This transition matrix may then be used in a computer simulation to calculate relevant outcomes. One possible outcome is the probability that a patient will reach a threshold value for blood glucose within h days after time t. If this probability is above a defined cut-off, say □ then that outcome is considered to have been forecast with a confidence level of \tilde{□}

Also (or alternatively), the forecast may be done using a Random Walk model as described in Section 3E, above. This forecasting may be performed, for example, on t consecutive days of blood glucose data collected before breakfast. Call this data Y₁ . . . Yₜ. This data is the input into the Random Walk model. If a constant trend term is to be included, the investigator may use the estimate for the term □ from the OLS model described in Section 1A, above. The output from the algorithm is a series of data Ŷₜ₊₁ . . . Yₜ₊ₕ representing the first h days forecasts for the patient's pre-breakfast blood glucose reading.

Also (or alternatively), the three-layer network described in section 3F, above, is used (for example) to predict hyperglycemic or hypoglycemic events. The inputs to the network may be any combination of the measurements taken (e.g., the previous day), including, but not limited to, blood glucose, blood pressure, physical activity, and weight measurements. Each day's readings may be labeled to enable the supervised learning procedure described above. Measurements preceding a day in which a hypoglycemic event occurs may be labeled (for example) with a −1, measurements preceding a day in which neither a hypoglycemic nor a hyperglycemic event occurs may be labeled (for example) with a 0, and measurements preceding a day in which a hyperglycemic event occurs may be labeled (for example) with a +1. The number of hidden units used in this system may range from one to n/10, where n denotes the number of training points available. Usage of more hidden units than this may lead to an unacceptably high test error, while the training error generally decreases as the number of hidden units increases. The activation function used may be one that fits many of the positive features valued in such a function. The function should be centered on zero and be antisymmetric, and thus we choose, in this example:
f(net)=αtanh(b*net).

While the overall range and slope may not be so important, for convenience we choose a=1.716 and b=2/3. This ensures that f′(0)=0.5 and that the linear range is −1<net<+1. For the parameters set above, the learning rate shall use as a starting point η=0.1. The learning rate should be lowered if the criterion function diverges during learning, or instead should be raised if learning seems unduly slow. The output of this network will then be a single number similar to the labels used in the learning process. A general rule can then be created to outline possible courses of action. For example (which example is intended to be illustrative and not restrictive), we may choose to intervene in the patient thinking that a hyperglycemic or hypoglycemic event may occur if the output of the network |z|≧0.5.

These processes may be used for any input of interest including, but not limited to, blood glucose measured pre or post lunch, pre or post dinner, bedtime, or according to the daily mean; or blood pressure (systolic and/or diastolic). The forecasts may be compared against threshold values previously defined in the system below (or above) which the patient may expect health problems. The eventual outcome could be coded as (1, 0, −1) signifying a forecasted value above the upper limit, a forecasted value within the limits, or a forecasted value below the lower limit respectively. The number of forecasted time periods, or “h”, may be any number greater or equal to one, although the uncertainty of the forecast increases the farther away it is from the present. Moreover, the time “window” used in training the model, 1 . . . T, may include any length of time (e.g., larger than thirty data points).

Of note, the forecasts of any or all of the listed inputs may be used in reports and other forms of communication to one or more of (but not limited to) the following parties: the patient's physician, the patient's caregiver, and/or the patient. Such reports may include (but not be limited to):

A. Blood Pressure

Physician Report: The outcome of the prediction for blood pressure may be used in charts, graphs, and/or textual reports generated by the system. Forecasts may be able to drive content and alerts based on whether the forecasted blood pressure (diastolic and/or systolic) is predicted to go above or below limits defined by the physician. Such analysis may also contribute to the body of knowledge driving changes in the patient's medication and/or other treatment regimen by the physician.

Caregiver Report: This content will be similar to the physician report, including charts, graphs and/or textual reports, but tailored specifically to the preferences of the caregiver. For instance, the caregiver may wish to have different threshold values for indicating a dangerous forecast. Forecasts may be able to drive content and alerts based on whether the forecasted blood pressure (diastolic and/or systolic) is predicted to go above or below limits defined by the caregiver.

Patient Report: The patient may receive alerts if in immediate danger of dangerous levels of systolic and/or diastolic blood pressure. Content describing how the patient may reduce the risk of having dangerously high or low blood pressure may accompany these alerts, in order to avoid a crisis situation.

B. Glucose

Physician Report: The outcome of the prediction for blood glucose may be used in charts, graphs, and/or textual reports generated by the system. Forecasts may be able to drive content and alerts based on whether the forecasted blood glucose, for measurements for pre and post breakfast, pre and post lunch, pre and post dinner, bedtime, and daily average, is predicted to go above or below limits defined by the physician. Such analysis may also contribute to the body of knowledge driving changes in the patient's medication and/or other treatment regimen by the physician.

Caregiver Report: This content will be similar to the physician report, including charts, graphs and/or textual reports, but tailored specifically to the preferences of the caregiver. For instance, the caregiver may wish to have different threshold values for indicating a dangerous forecast. Forecasts may be able to drive content and alerts based on whether the forecasted blood glucose, for measurements for pre and post breakfast, pre and post lunch, pre and post dinner, bedtime, and daily average, is predicted to go above or below limits defined by the caregiver.

Patient Report: The patient may receive alerts if in immediate danger of dangerous levels for blood glucose for pre and post breakfast, pre and post lunch, pre and post dinner, bedtime, and the daily average. Content describing how the patient may reduce the risk of having dangerously high or low blood glucose may accompany these alerts, in order to avoid a crisis situation such as hypoglycemia or hyperglycemia, respectively.

Reference will now be made to another example of data and data processing according to an embodiment of the invention (of course, such example is intended to be illustrative and not restrictive). In this example a Type II diabetic patient (referred to in this example as “SUBJECT”) has been generating data for six months. The data has been provided as follows (this is SUBJECT data sent to the PNC for ONE day):

1) Blood Sugar reading

| Time of Reading | Reading (mg/dcl) |
|---|---|
| Mean (0600-1000) | 250 |
| Mean (1000-1400) | 200 |
| Mean (1400-1800) | 300 |
| Mean (1800-2200) | 220 |
| Mean (2200-0600) | 180 |

2) Blood Pressure Readings

| Time of Reading | Reading (mmHg) |
|---|---|
| 0900 | 160/82 |
| 1230 | 170/84 |
| 1800 | 180/90 |

3) Physical Activity

| Time of Reading | Reading(calories burned cumulative) |
|---|---|
| (cumulative) 2200 | 1800 |

4) Weight_{—}

| Time of Reading | Reading (kg) |
|---|---|
| 0700 | 330 |

Example analysis of SUBJECT data performed according to an embodiment of the invention utilizing predictive modeling:
1) Warning signals produced:
   A. Because dinner reading has been higher than 280 more than 3 times in past 90 days, a warning or “flag” is raised regarding high blood sugar at dinner.
   B. Physical Activity is lower than the prescribed minimum value for the patient (1900 for SUBJECT).
2) Predictions (Using GARCH model as described below)
   A. For purposes of the model:
      t is today
      1 . . . t−1 is all days prior to today
      t+1 is tomorrow
   B. All data are averages over the course of the day. For instance, for the data given for SUBJECT, “today's” data would look like:
      Blood sugar=230 mg/dcl
      Blood pressure=170/85 mmHg
      Physical Activity=1800 cals
      Weight=330 kg
   C. The inputs into the GARCH model are as follows:
      X₁ is SUBJECT's full time series for systolic blood pressure (X₁₁ . . . . X₁ₜ)
      X₂ is SUBJECT's full time series for diastolic blood pressure (X₂₁ . . . X₂ₜ)
      X₃ is SUBJECT's full time series for physical activity (X₃₁ . . . X₃ₜ)
      X₄ is SUBJECT's full time series for weight. (X₄₁ . . . X₄ₜ)
      y is SUBJECT's blood glucose level. (y₁ . . . yₜ)
   D. We are predicting yₜ₊₁ according to the GARCH model algorithm described previously in the equation section. All other variables and coefficients appearing in the model are calculated using the maximum likelihood algorithm.
   1. Blood sugar prediction according to predictive modeling for tomorrow is 215. That is within “normal” range for chronically ill patient SUBJECT (within one standard deviation of average daily mean), but not within normal range for a healthy person.
   2. Blood Pressure over past 30 days is increasing as measured by OLS.
   3. Physical Activity over past 60 days is declining as measured by OLS.
   4. Blood Sugar variance over past 30 days is increasing by using D-Statistic procedure.
   5. Weight over past 60 days is declining by using OLS.
3) Such results from the mathematical analysis of the present invention establish that the chronically ill SUBJECT has poorly controlled diabetes and is at high risk of continued elevated blood sugars and extreme variance. Declining physical activity is contributing to this high risk situation as is elevated and rising blood pressure. Thus, the data analysis reveals a picture of extremely high medical risk. Without active intervention, this patient is at very high risk of developing microvascular complications of diabetes (renal failure, blindness, peripheral nerve dysfunction and infections leading to amputations) due to persistent high average glucoses. The patient is also at very high risk of developing macrovascular complications of diabetes (heart-disease and stroke) due to elevated glucose variance. The complications will lead to both acute and chronic medical events requiring hospitalizations and other costly-interventions. Since the intervention is helpful in being able to detect and characterize these risk factors and support decreased cycle time in establishing appropriate interventions, evaluating their impact, and enhancing the interventions until glucose and blood pressure are controlled, the aforementioned complications may be prevented, thus avoiding the need for costly hospitalizations, amputations, and dialysis.
4) The above example provides an early warning which takes place in advance of SUBJECT's next scheduled medical appointment. The example as well provides the predictive modeling tools to facilitate a variety of interventions designed to lower patient SUBJECT's blood sugar in addition to lowering blood pressure and an increase in physical activity. SUBJECT is more likely than not to have non-emergency intervention and receive treatment in advance—without emergency room intervention (saving the health care system emergency expenses). A plan to motivate SUBJECT can be introduced focused upon avoiding kidney failure. Such a plan may include, but not be limited to, counseling, dietary change, nutritional input, and suggested changes in his pharmacological routine and physical activity. The tools of the invention may also (or alternatively) facilitate interventions designed to resolve problems with which subject may have which impede his level of physical activity.

In yet another embodiment, by utilizing appropriate variables to generate time series, the present invention provides the foundation for integrated analysis of appropriate factors and facilitates a separation of cause and effect to allow for the development of individualized chronically ill patient care, as in the case of the diabetic patient (for example).

Further, such care as may be implemented by the invention may be used to improve the care of chronically ill patients, bringing reinforcement to the patient in the form of periodic output. In this regard, chronically ill patients such as, for example, diabetics, may be given the ability to participate daily in their treatment protocol. Improving care for chronically ill patients through the essentially continuous care possible through use of the invention may help liberate the user of the invention, such as the chronically ill patient and/or a healthcare provider, from the cost of simplistic statistics and large group averaging.

In one specific example (which example is intended to be illustrative and not restrictive), output information may be communicated to the patient, caregiver and/or healthcare provider within a range of 2-24 hour intervals. Such output information may be communicated (e.g., to the patient) via a “virtual companion”, for example, a computer image representing a nurse. The virtual companion may provide feedback to the patient such as (but not limited to): (a) watch what you eat at dinner; (b) recommend increasing exercise to control blood pressure—mention yesterday's lack of exercise; (c) need for immediate medical appointment to adjust medications.

In another specific example (which example is intended to be illustrative and not restrictive), a Diabetes Care System (“DCS”) may be established, which utilizes the real time, comprehensive systems and methods discussed above to change and improve chronically ill patient's care, as in the instance of diabetic care. For example, instead of monthly updates, caregivers may receive periodic (e.g., hourly, daily, weekly) updates on testing, food intake, exercise, weight and/or oxygen saturation in the blood. Based upon the algorithms and predictive modeling of the invention, patients may receive periodic feedback on actions they should take to maintain and/or improve their health.

Moreover, the likelihood of catastrophic medical events such as high or low blood sugar episodes in a diabetic may thus be mitigated through sophisticated analysis of the patient data and use of predictive models, each of which may, for example, rely solely on the patient's own data (of note, the likelihood of catastrophe may be reduced by enabling an accurate process by which to predict when such events may take place, thus providing an alert for the patient and the patient's caregiver/healthcare provider in enough time to facilitate appropriate intervention).

Another embodiment of the invention may include the following: (a) ascertaining a chronically ill patient's disease type; (b) next, the data regiment that characterizes that chronically ill patient is properly identified and provides the basis for predictive modeling (such predictive models may be used to control the incidence of catastrophic medical events); (c) time series are evaluated to provide information that can be used to structure treatment protocols; (d) mathematical techniques are then used to assess the efficacy of these protocols focusing intervention on those approaches that work for that particular chronically ill patient (this may allow for direct improvement of the chronically ill patient's condition while avoiding the employment of ineffective resources).

In another embodiment of the invention the PNC may record, store, analyze and/or predicatively model the data to recognize changes in the patient-data. Changes may include, for example, illness or health development and variance in condition. Further, measured data may be integrated with additional data (e.g., lifestyle data and/or doctor-generated information) to provide essentially continual evaluation of chronically ill patient progress by using the nonlinear analysis of time series combined with systems identification mathematics.

Of note, the invention may be implemented using any appropriate computer hardware and/or computer software. In this regard, those of ordinary skill in the art are well versed in the type of computer hardware that may be used (e.g., a mainframe, a mini-computer, a personal computer (“PC”), a network (e.g., an intranet and/or the Internet)), the type of computer programming techniques that may be used (e.g., object oriented programming), and the type of computer programming languages/constructs that may be used (e.g., C++, Basic, HTML, ASP). The aforementioned examples are, of course, illustrative and not restrictive.

While a number of embodiments of the invention have been described, it is understood that these embodiments are illustrative only, and not restrictive, and that many modifications may become apparent to those of ordinary skill in the art. For example, certain methods have been described herein as being “computer implemented” or “computer implementable”. In this regard it is noted that while such methods can be implemented using a computer, the methods do not necessarily have to be implemented using a computer. Also, to the extent that such methods are implemented using a computer, not every step must necessarily be implemented using a computer. Further, while the invention has been described to a large extent in connection with diabetes, the invention could, of course, be applied to any other desired medical condition(s). For example, the diabetes-related data may be replaced by (or augmented with) other input from the patient/user, such as electrocardiogram signals for health indicative parameters relating to heart and/or tissue conditions. Further still, various time periods (e.g., periodic time periods) related to the invention may be selected from the group including, but not limited to: (a) by the second; (b) by the minute; (c) daily; (d) weekly; (e) monthly. Further still, the various steps may be performed in any desired order.

What is claimed is:

1. A computer implemented method for predictive modeling of a condition of a patient, comprising:
making a plurality of measurements of a physical parameter exhibited by the patient;
organizing the plurality of measurements into time series data; and
applying a variance detection algorithm to the time series data to predict a future condition of the patient.

2. The method of claim 1, wherein the variance detection algorithm comprises an algorithm selected from the group including: (a) an ARIMA Model; (b) a D-Statistic Procedure; and (c) a Non-Parametric Approach.

3. The method of claim 2, wherein the ARIMA Model comprises a formula specified at least in part as:
Yₜ=α₁Yₜ₋₁+ . . . +αₚYₜ₋ₚ+eₜ+eₜ+β₁eₜ₋₁+ . . . +β_{q}e_{t-q}.

4. The method of claim 2, wherein the D-Statistic Procedure comprises a formula specified at least in part as:
$${D}_{k} = \frac{{C}_{k}}{{C}_{T}} - \frac{k}{T} .$$

5. The method of claim 2, wherein the Non-Parametric Approach comprises a formula specified at least in part as:
U_{t,T}=2Wₜ−t(T+1).

6. The method of claim 1, wherein the prediction of the future condition of the patient is carried out in real time, as additional measurements are made and organized into time series data.

7. The method of claim 6, wherein the prediction of the future condition of the patient is provided to at least one of: (a) the patient; (b) a caregiver associated with the patient; and (c) a healthcare provider associated with the patent.

8. The method of claim 7, wherein the healthcare provider is selected from the group including: (a) a doctor; and (b) a nurse.

9. The method of claim 1, wherein the physical parameter is selected from the group including: (a) blood glucose level; (b) blood pressure; (c) blood oxygen saturation; (d) electrical activity; (e) weight; and (f) physical activity.

10. The method of claim 1, wherein a plurality of measurements are made of each of a plurality of physical parameters exhibited by the patient.

11. The method of claim 10, wherein the patient is a chronically ill patient.

12. A computer implemented method for predictive modeling of a condition of a patient, comprising:
making a plurality of measurements of a physical parameter exhibited by the patient;
organizing the plurality of measurements into time series data; and
applying a prediction algorithm to the time series data to predict a future condition of the patient;
wherein the prediction algorithm comprises an algorithm selected from the group including: (a) a General ARMAX Model; (b) a GARCH Model; (c) Kalman Filtering; (d) a Markov Model; (e) a Random Walk Model; (f) a Multilayer Neural Network; and (g) an Extreme Value Analysis.

13. The method of claim 12, wherein the General ARMAX Model comprises a formula specified at least in part as:
$${Y}_{t} = C + {\sum }_{i = 1}^{R} {α}_{i} {Y}_{t - i} + {ɛ}_{t} + {\sum }_{j = 1}^{M} {β}_{j} {ɛ}_{t - j} + {\sum }_{k = 1}^{N} {ϕ}_{k} X ( t , k ) .$$

14. The method of claim 12, wherein the GARCH Model comprises a formula specified at least in part as:
$${h}_{t} = {α}_{0} + {\sum }_{i = 1}^{q} {α}_{i} {X}_{t - i}^{2} + {\sum }_{j = 1}^{p} {β}_{j} {h}_{t - j} .$$

15. The method of claim 12, wherein the Kalman Filtering comprises a formula specified at least in part as:
Xₜ=AXₜ₋₁+Bμₜ₋₁+ωₜ₋₁.

16. The method of claim 12, wherein the Markov Model comprises a formula specified at least in part as:
P(Xₜ=j|X₀=i₀,X₁=i₁, . . . Xₜ₋₁=iₜ₋₁)=P(Xₜ=j|Xₜ₋₁=iₜ₋₁).

17. The method of claim 12, wherein the Random Walk Model comprises a formula specified at least in part as:
Yₜ=Yₜ₋₁+α.

18. The method of claim 12, wherein the Multilayer Neural Network comprises a formula specified at least in part as:
$${net}_{j} = {\sum }_{i = 1}^{d} {x}_{i} {w}_{ji} + {w}_{j0} = {\sum }_{i = 0}^{d} {x}_{i} {w}_{ji} ≡ {W}^{t} X .$$

19. The method of claim 12, wherein the Extreme Value Analysis includes Parameter Fitting and comprises a formula specified at least in part as:
$$p ( D \vert θ ) = {\prod }_{k = 1}^{n} p ( {x}_{k} \vert θ ) .$$

20. The method of claim 12, wherein the Extreme Value Analysis includes Goodness-Of-Fit Testing and comprises a formula specified at least in part as:
$${χ}^{2} = {\sum }_{i = 1}^{k} {( {O}_{i} - {E}_{i} )}^{2} / {E}_{i} .$$

21. The method of claim 12, wherein the prediction of the future condition of the patient is carried out in real time, as additional measurements are made and organized into time series data.

22. The method of claim 21, wherein the prediction of the future condition of the patient is provided to at least one of: (a) the patient; (b) a caregiver associated with the patient; and (c) a healthcare provider associated with the patent.

23. The method of claim 22, wherein the healthcare provider is selected from the group including: (a) a doctor; and (b) a nurse.

24. The method of claim 12, wherein the physical parameter is selected from the group including: (a) blood glucose level; (b) blood pressure; (c) blood oxygen saturation; (d) electrical activity; (e) weight; and (f) physical activity.

25. The method of claim 12, wherein a plurality of measurements are made of each of a plurality of physical parameters exhibited by the patient.

26. The method of claim 25, wherein the patient is a chronically ill patient.

27. A computer implemented method for predictive modeling of a condition of a patient, comprising:
making a plurality of measurements of a physical parameter exhibited by the patient;
organizing the plurality of measurements into time series data; and
applying a trend detection algorithm to the time series data to predict a future condition of the patient;
wherein the trend detection algorithm comprises an algorithm selected from the group including: (a) a Piece-Wise Linear Model; and (b) Pattern Recognition.

28. The method of claim 27, wherein the prediction of the future condition of the patient is carried out in real time, as additional measurements are made and organized into time series data.

29. The method of claim 28, wherein the prediction of the future condition of the patient is provided to at least one of: (a) the patient; (b) a caregiver associated with the patient; and (c) a healthcare provider associated with the patent.

30. The method of claim 29, wherein the healthcare provider is selected from the group including: (a) a doctor; and (b) a nurse.

31. The method of claim 27, wherein the physical parameter is selected from the group including: (a) blood glucose level; (b) blood pressure; (c) blood oxygen saturation; (d) electrical activity; (e) weight; and (f) physical activity.

32. The method of claim 27, wherein a plurality of measurements are made of each of a plurality of physical parameters exhibited by the patient.

33. The method of claim 32, wherein the patient is a chronically ill patient.

34. The method of claim 1, wherein the steps are carried out in the order recited.

35. The method of claim 12, wherein the steps are carried out in the order recited.

36. The method of claim 27, wherein the steps are carried out in the order recited.
